(19) United States
(12) Patent Application Publication
(10) Pub. No.: US 2024/0377936 A1
(43) Pub. Date: Nov. 14, 2024

(54) USER INTERFACES WITH DYNAMIC DISPLAY OF MAP INFORMATION

(71) Applicant: Apple Inc., Cupertino, CA (US)

(72) Inventors: Leo Emile Jean Pierre VALLET, Culver City, CA (US); Kirill NEGODA, San Jose, CA (US); William N. DANNER, Santa Cruz, CA (US)

(21) Appl. No.: 18/660,131

(22) Filed: May 9, 2024

Related U.S. Application Data
(60) Provisional application No. 63/501,374, filed on May 10, 2023.

(51) Int. Cl. G06F 3/04845; G01C 21/36; G06F 3/04842; G06F 3/0488

(52) U.S. Cl. CPC G06F 3/04845; G01C 21/367; G06F 3/04842; G06F 3/0488; G06F 2203/04806

(57) ABSTRACT

Some embodiments described in this disclosure are directed to an electronic device displaying a map of a area from different viewpoints within a map user interface of a map application. In some embodiments, the electronic device initiates display of or controls display of map information via a first display generation component and a second display generation component.

### CROSS-REFERENCE TO RELATED APPLICATIONS

This application claims the benefit of U.S. Provisional Application No. 63/501,374, filed May 10, 2023, the contents of which are herein incorporated by reference in their entirety for all purposes.

### FIELD OF THE DISCLOSURE

This disclosure relates generally to user interfaces presenting map features based on the number of displays.

### BACKGROUND OF THE DISCLOSURE

User interaction with electronic devices has increased significantly in recent years. These devices can be devices such as computers, tablet computers, televisions, multimedia devices, or mobile devices. In some circumstances, users want to efficiently view map information using one or more displays.

### SUMMARY OF THE DISCLOSURE

Providing efficient ways of presenting content to a user via a maps application of an electronic device may improve the user's experience with the electronic device and reduce the number of inputs needed to view relevant information in a maps application, thereby reducing power usage and improving the battery life of the electronic device.

Some embodiments described in this disclosure are directed to an electronic device configured to initiate display of or control display of map information via one or more displays of a vehicle. By dynamically presenting a map of an area from a variety of viewpoints via one or more displays of the vehicle, the electronic device decreases time and processing required to display map information, which is particularly important when operating a vehicle. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6V illustrate examples of an electronic device displaying a map of a geographic area from different viewpoints within a map user interface of a map application.

FIG. 7 is a flow diagram illustrating a method in which an electronic device displaying a map of a geographic area from different viewpoints within a map user interface of a map application according to some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

There is a need for an electronic device to present map information related to an area from different viewpoints. Such techniques can reduce the need for subsequent inputs to zoom in or out of the map of the area, thus enhancing the user's interaction with the device. Further, such techniques can reduce processor and battery power otherwise wasted on user inputs to perform operations to zoom in or out of the map of the area. In some embodiments, the area is a geographic area or another type of area other than a geographic area, such as a topographic area or a nautical area.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

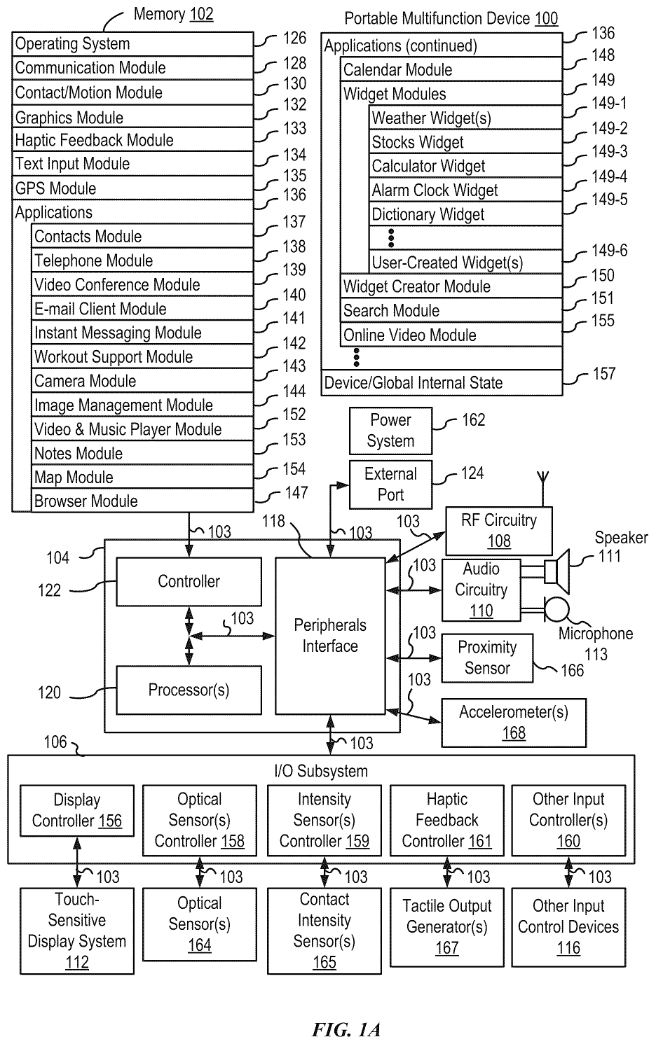

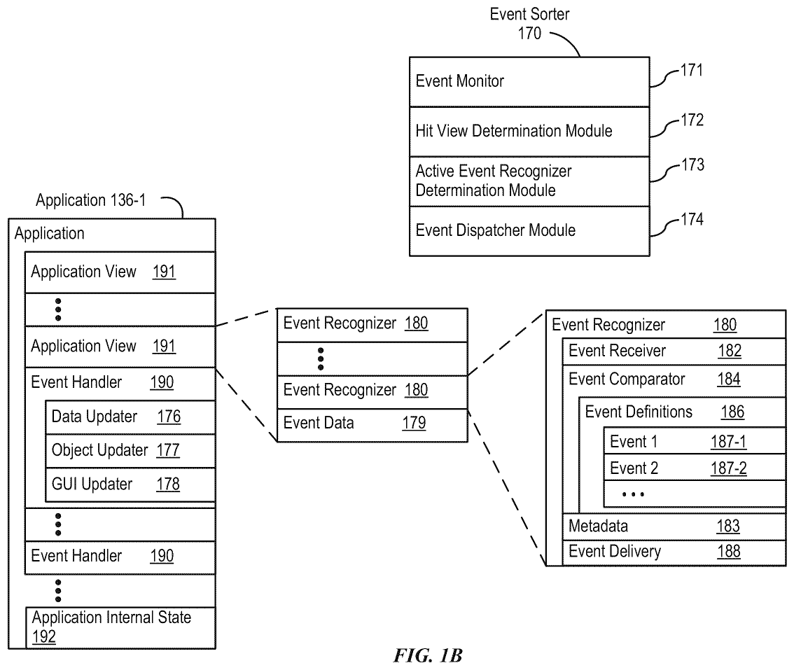

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

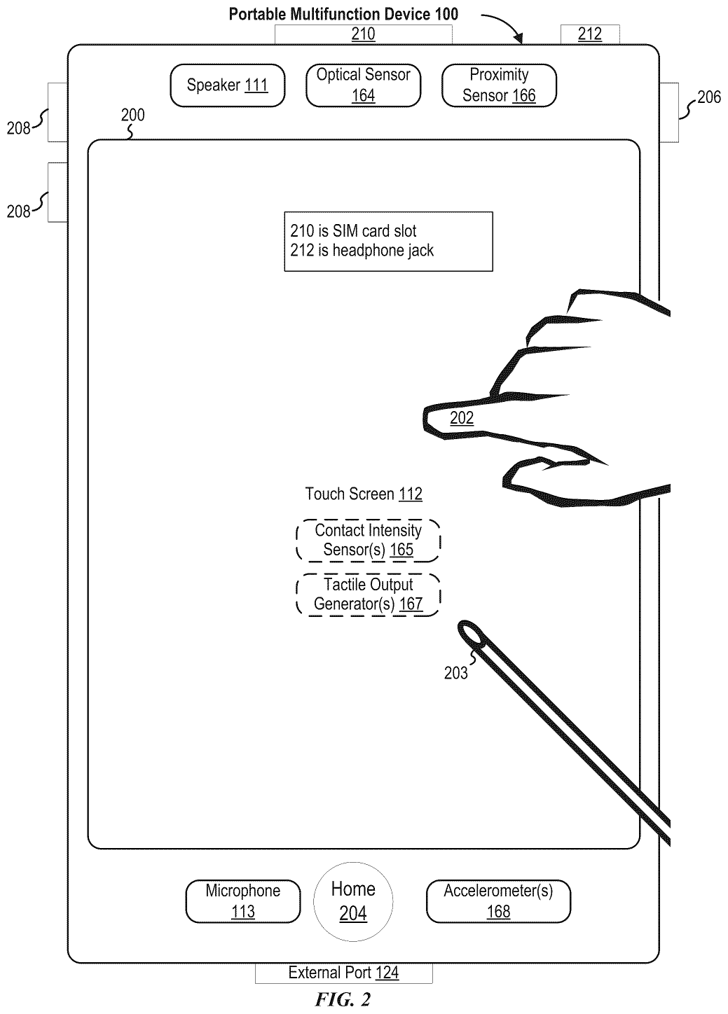

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

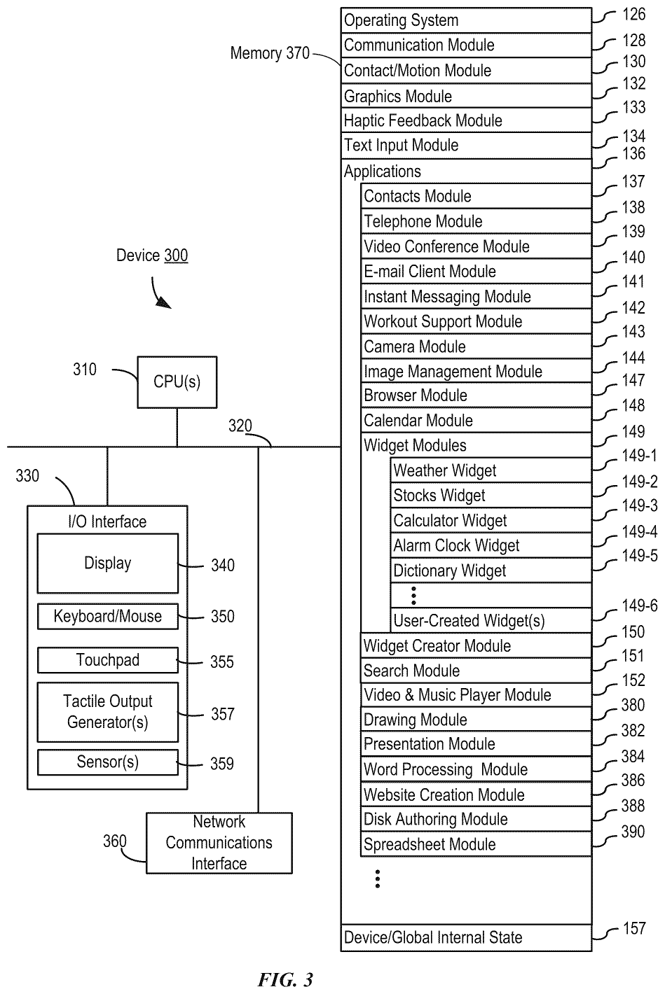

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

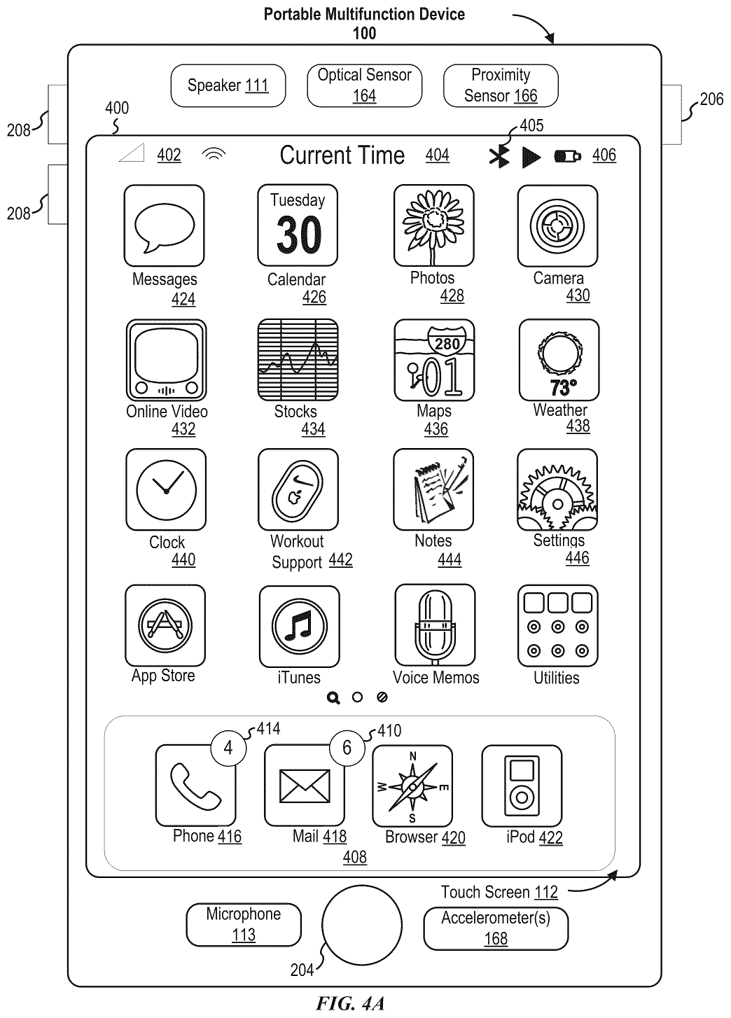

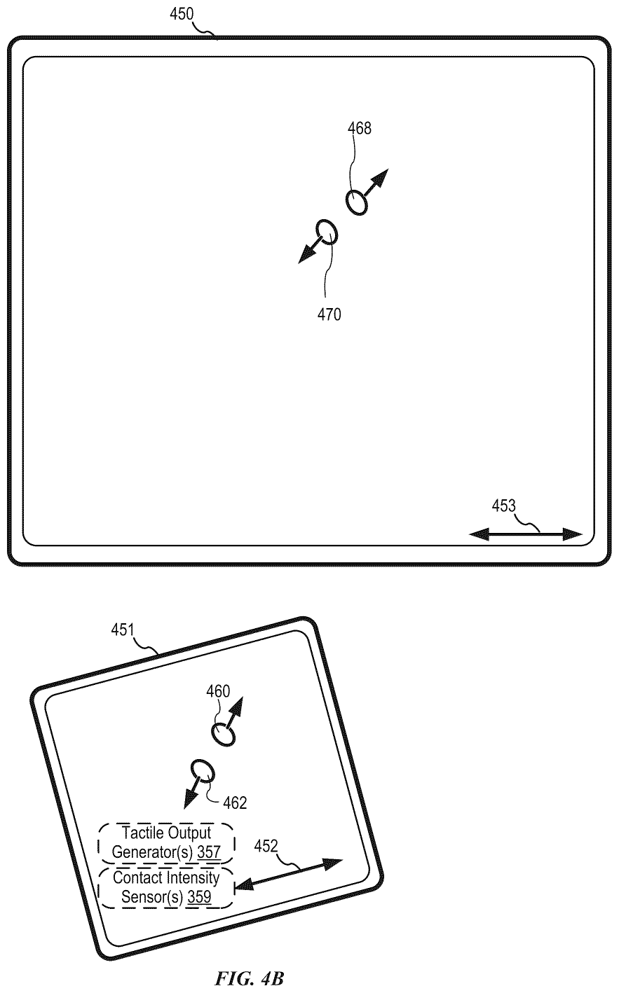

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
Icon 416 for telephone module 138, labeled “Phone,” which optionally includes an indicator 414 of the number of missed calls or voicemail messages;
Icon 418 for e-mail client module 140, labeled “Mail,” which optionally includes an indicator 410 of the number of unread e-mails;
Icon 420 for browser module 147, labeled “Browser;” and
Icon 422 for video and music player module 152, also referred to as iPod (trademark of Apple Inc.) module 152, labeled “iPod;” and
Icons for other applications, such as:
Icon 424 for IM module 141, labeled “Messages;”
Icon 426 for calendar module 148, labeled “Calendar;”
Icon 428 for image management module 144, labeled “Photos;”
Icon 430 for camera module 143, labeled “Camera;”
Icon 432 for online video module 155, labeled “Online Video;”
Icon 434 for stocks widget 149-2, labeled “Stocks;”
Icon 436 for map module 154, labeled “Maps;”
Icon 438 for weather widget 149-1, labeled “Weather;”
Icon 440 for alarm clock widget 149-4, labeled “Clock;”
Icon 442 for workout support module 142, labeled “Workout Support;”
Icon 444 for notes module 153, labeled “Notes;” and
Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

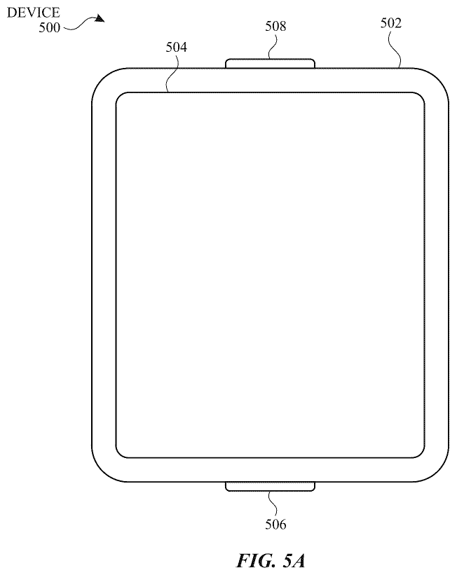

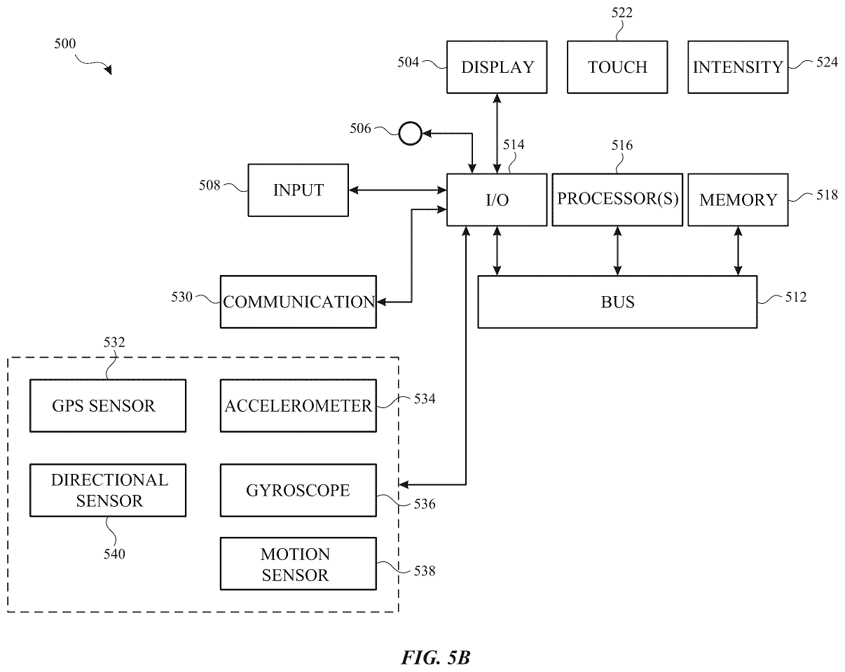

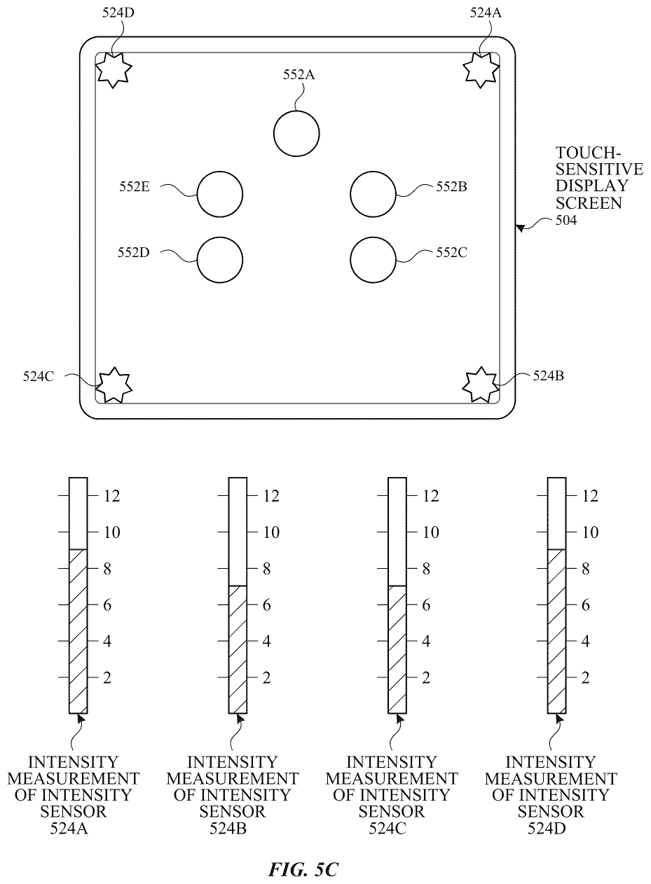

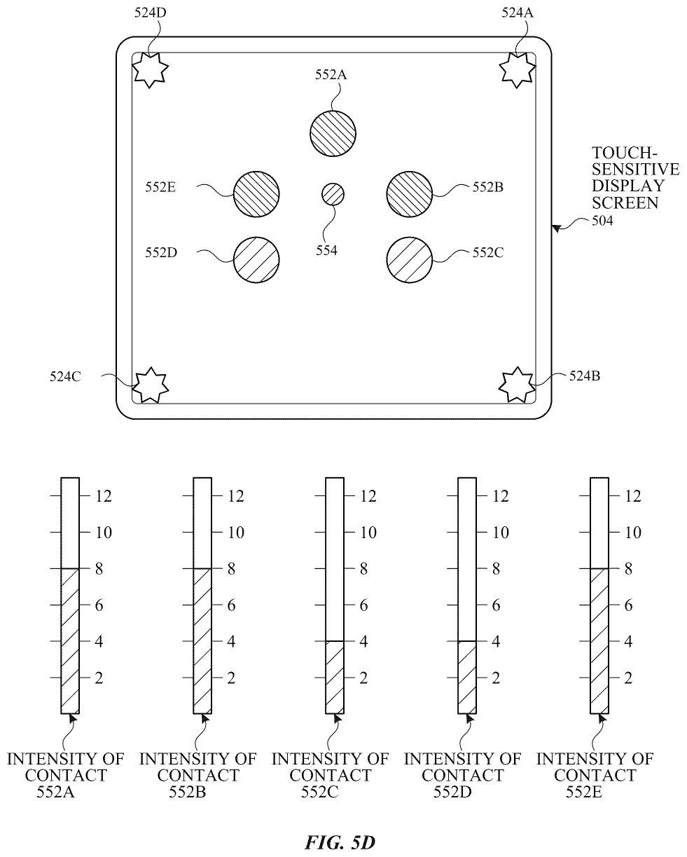

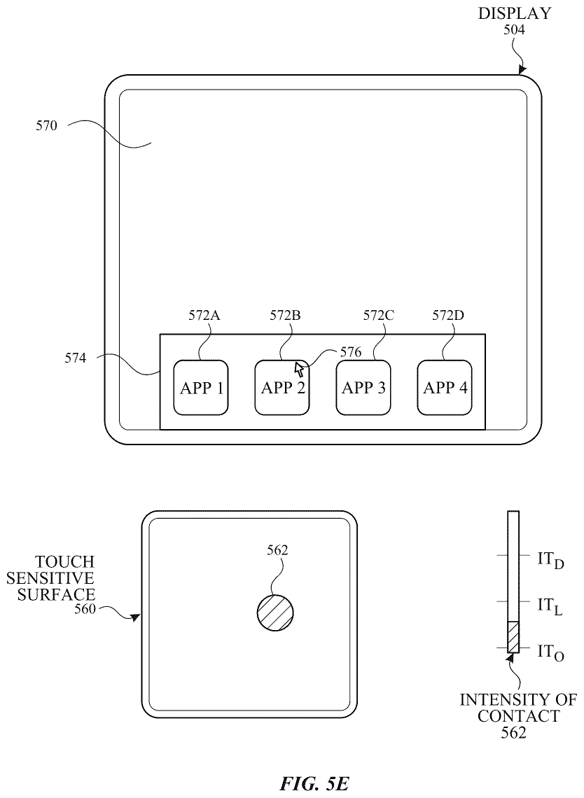

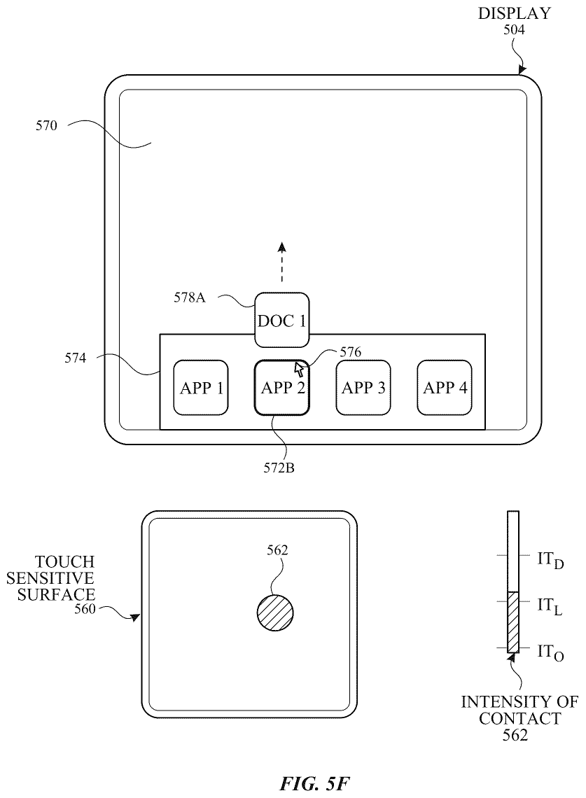

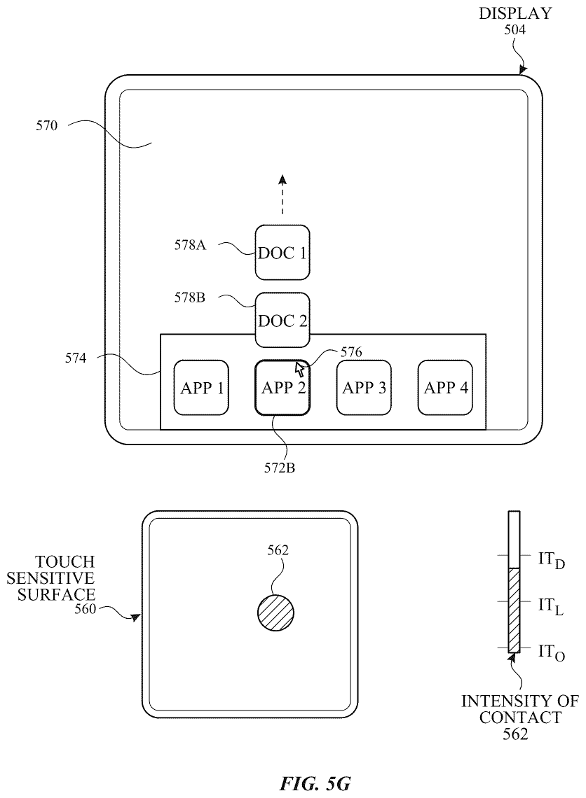

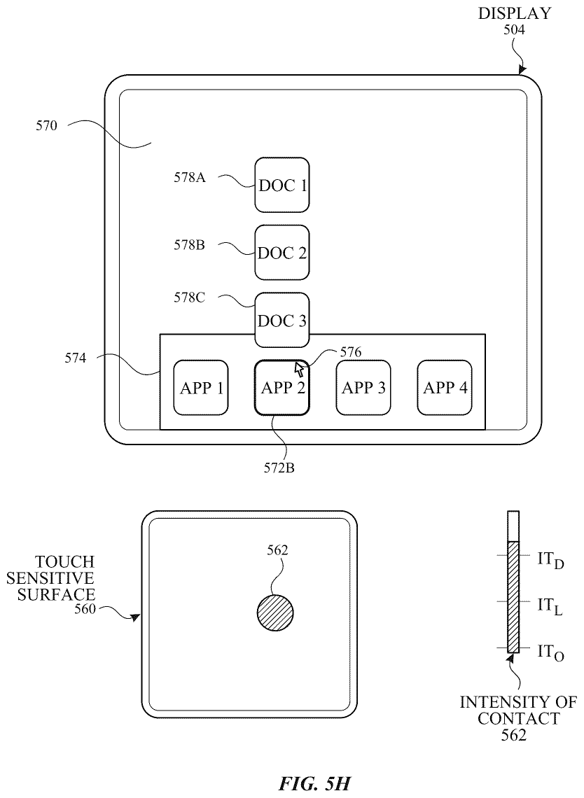

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes

### User Interfaces for Displaying Map Information in a Map Application

Users interact with electronic devices in many different manners. In some embodiments, an electronic device presents a map of an area within a user interface of a map application via a first display generation component. In some embodiments, while presenting the map, via the first display generation component, the electronic device detects activation of a second display generation component, different from the first display generation component. The embodiments described below provide ways in which an electronic device presents map information related to the area from different vantage points, without the need for subsequent inputs to zoom in or out of the map of the area, thus enhancing the user's interaction with the device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

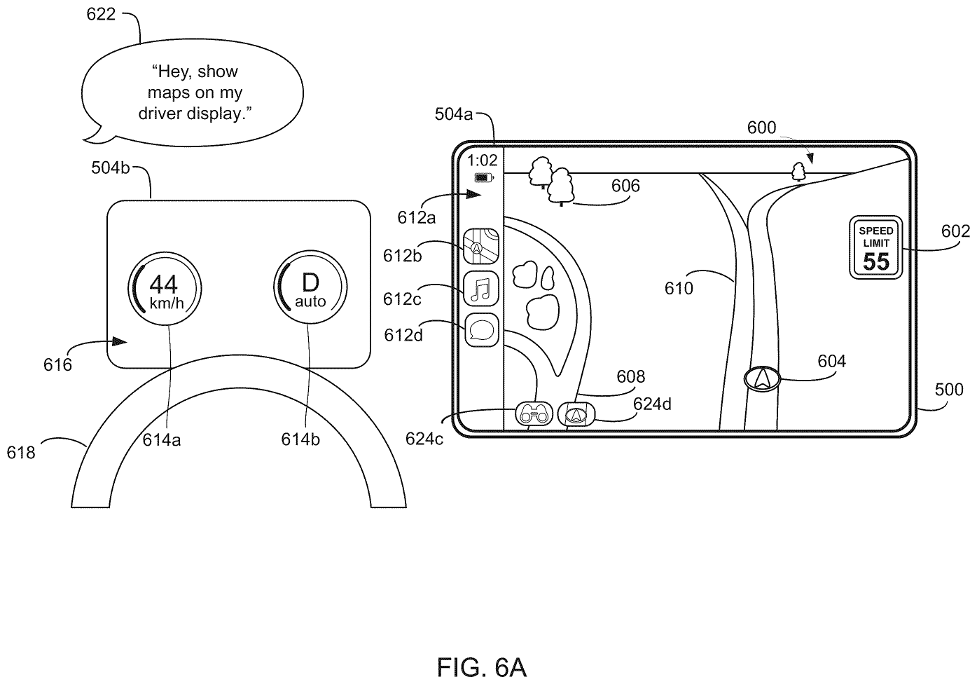

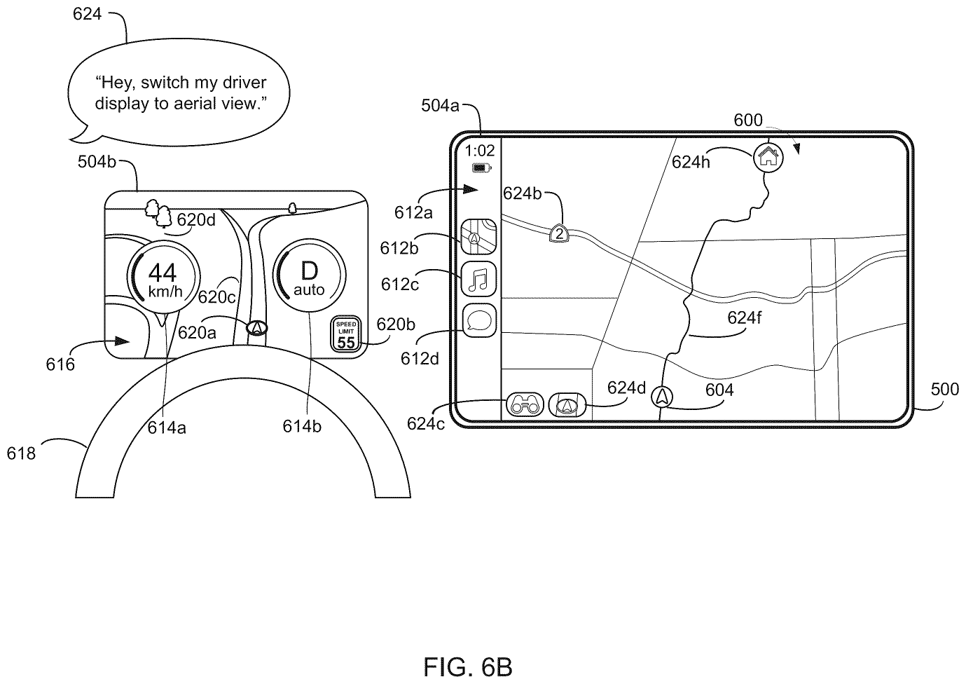

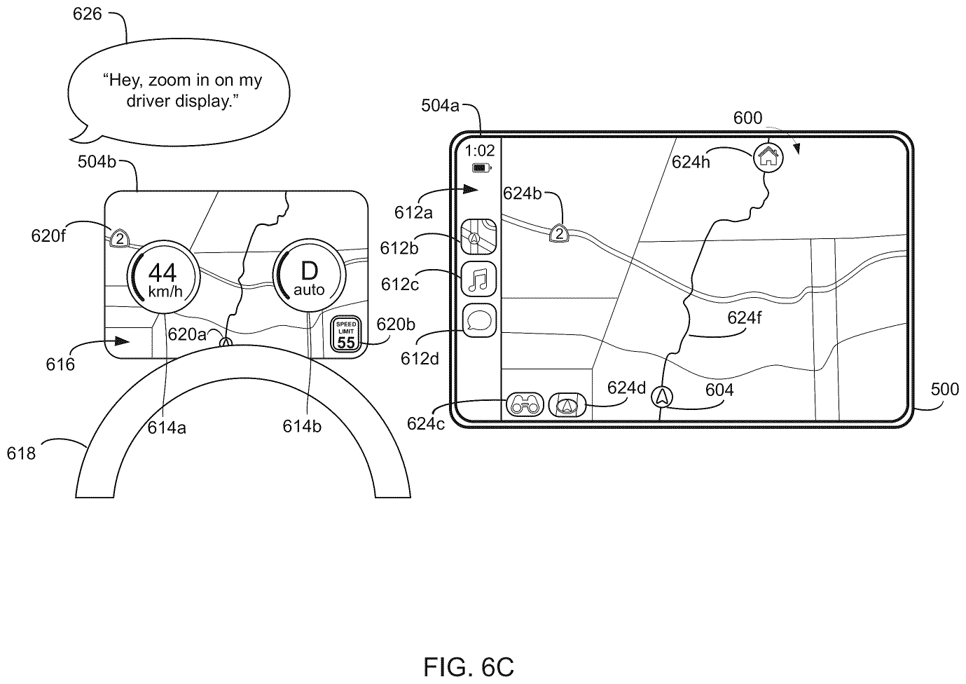

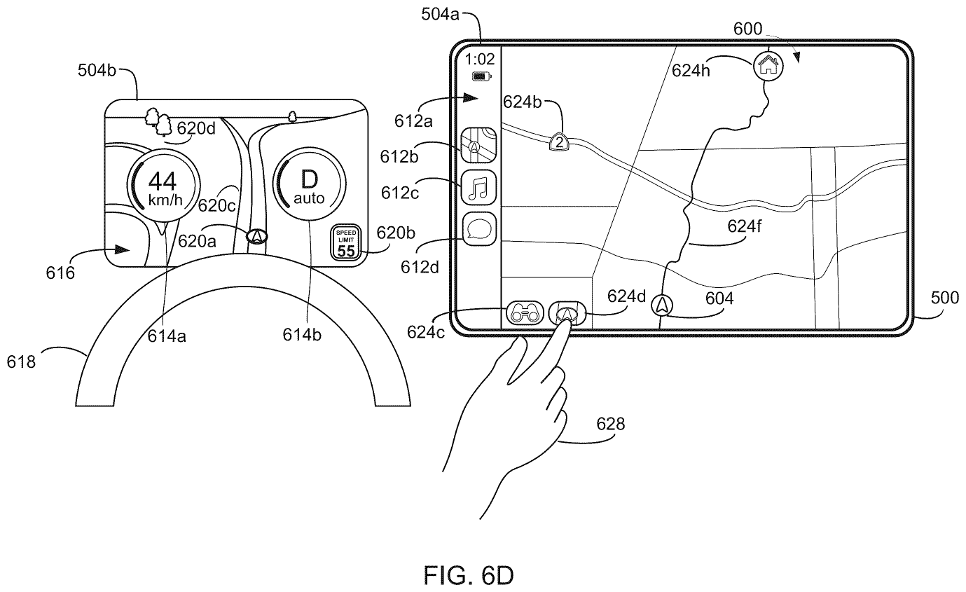

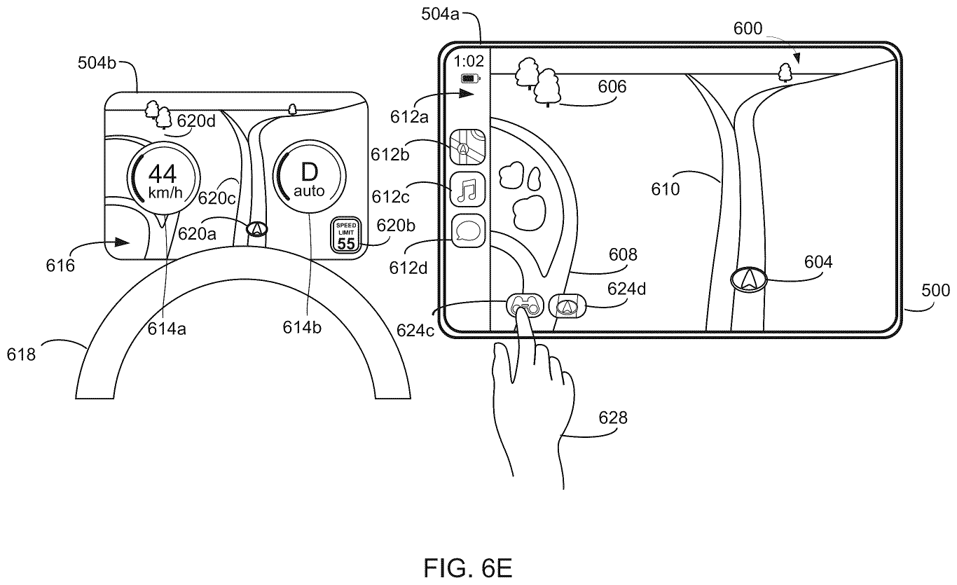

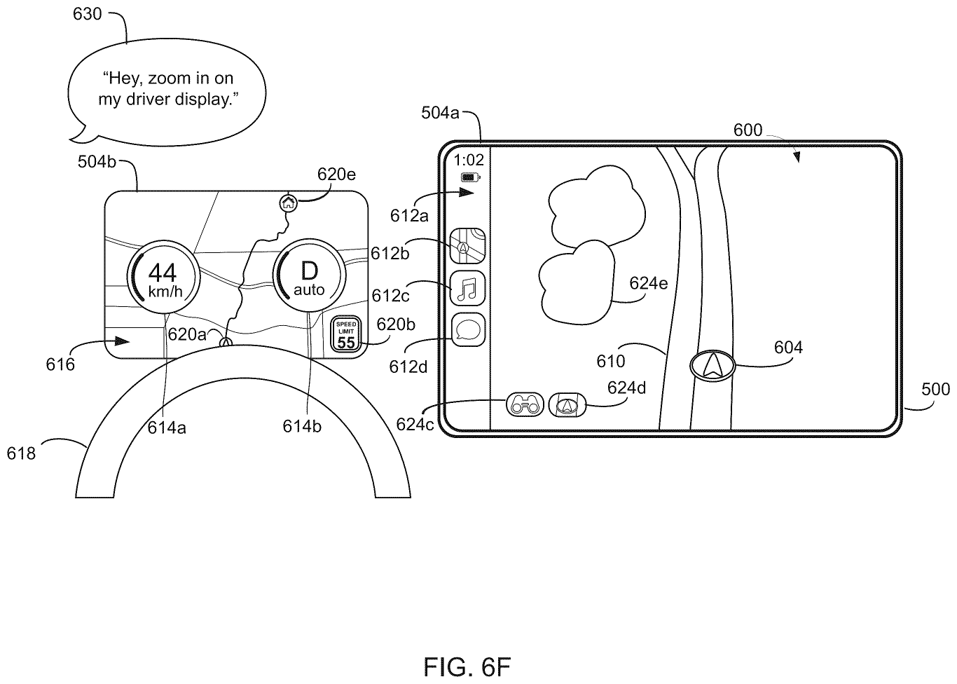

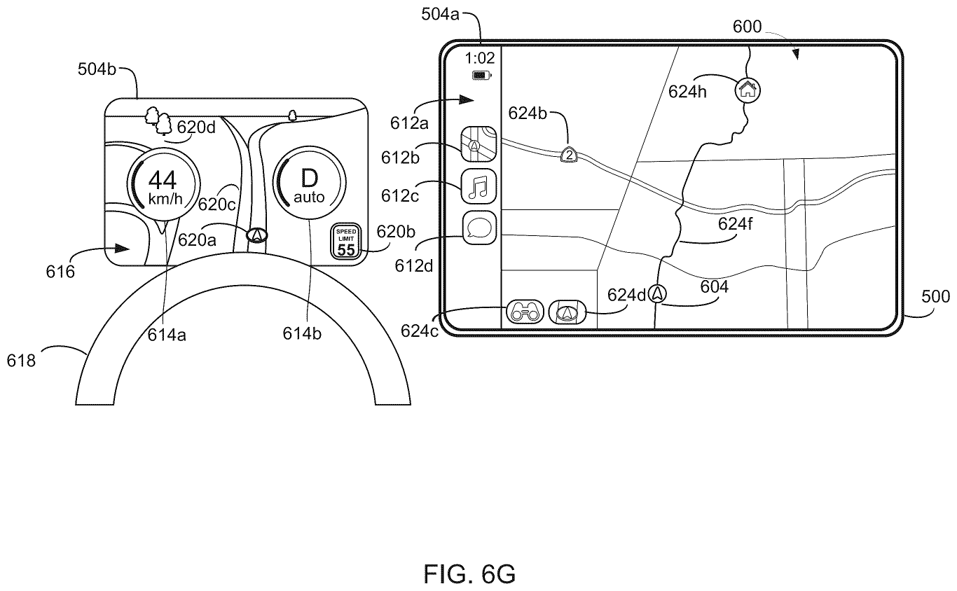

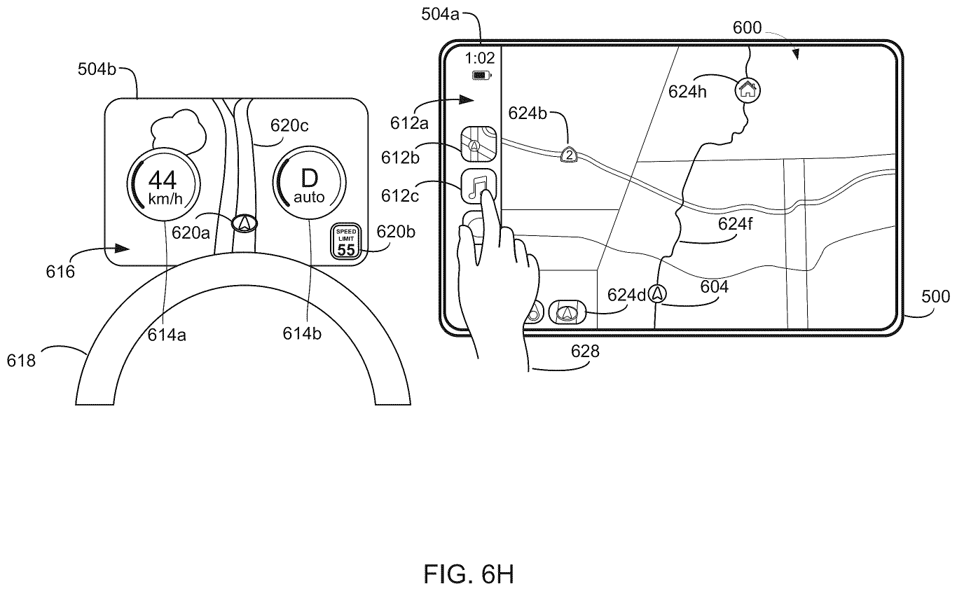

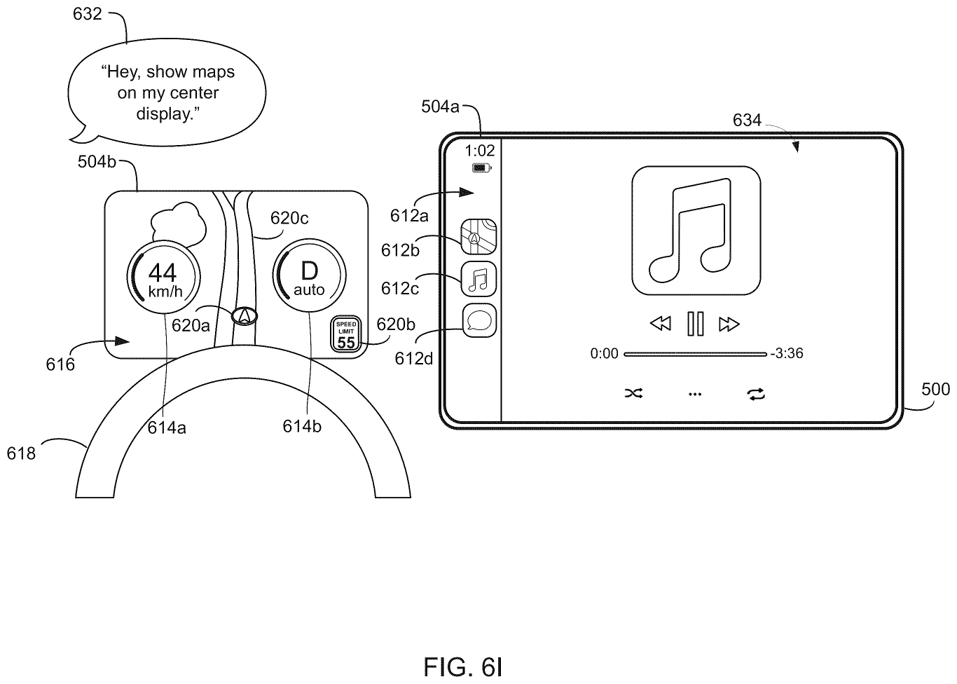

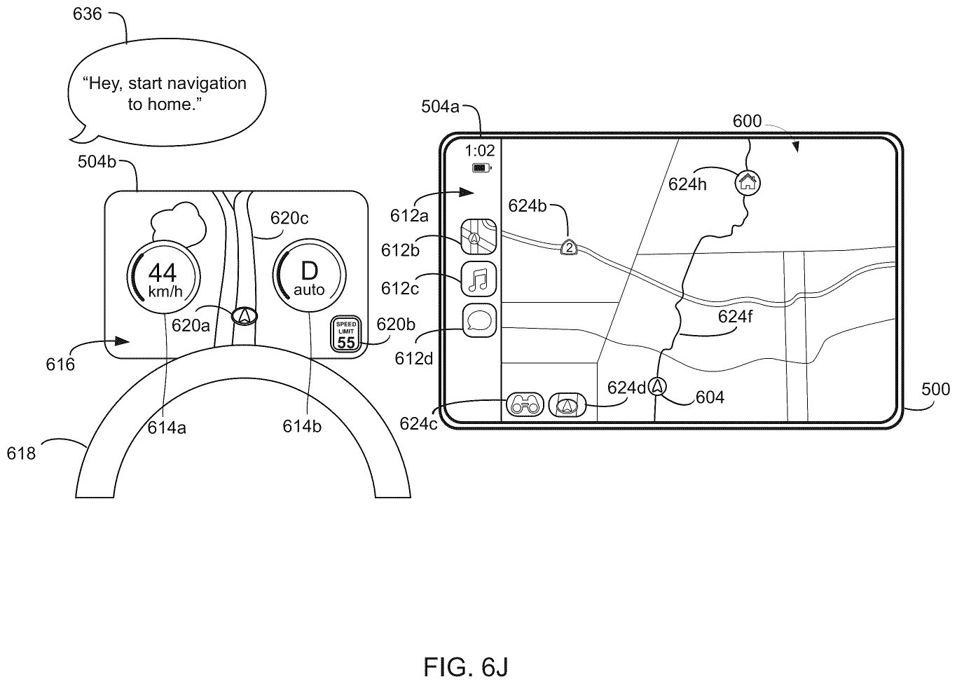

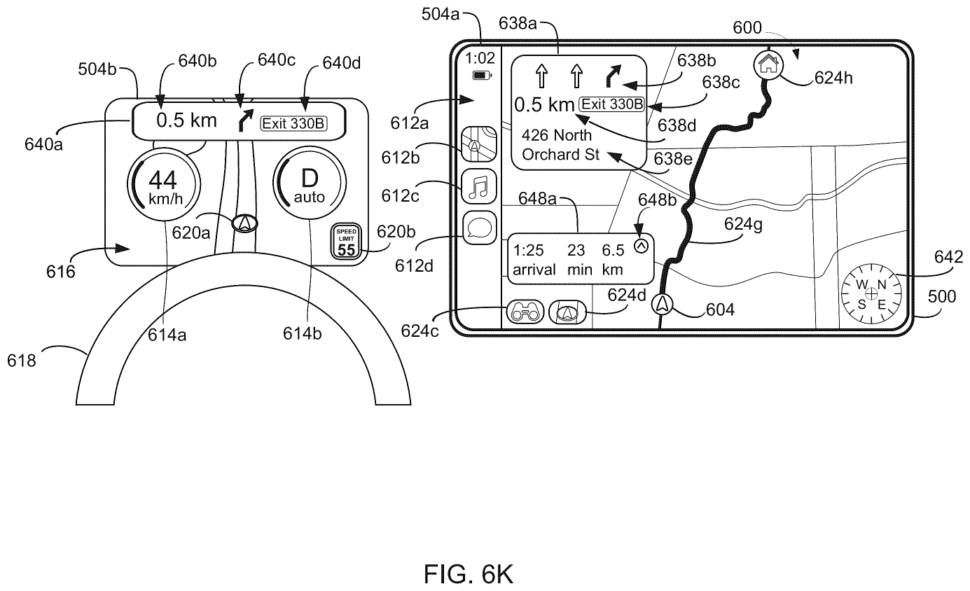

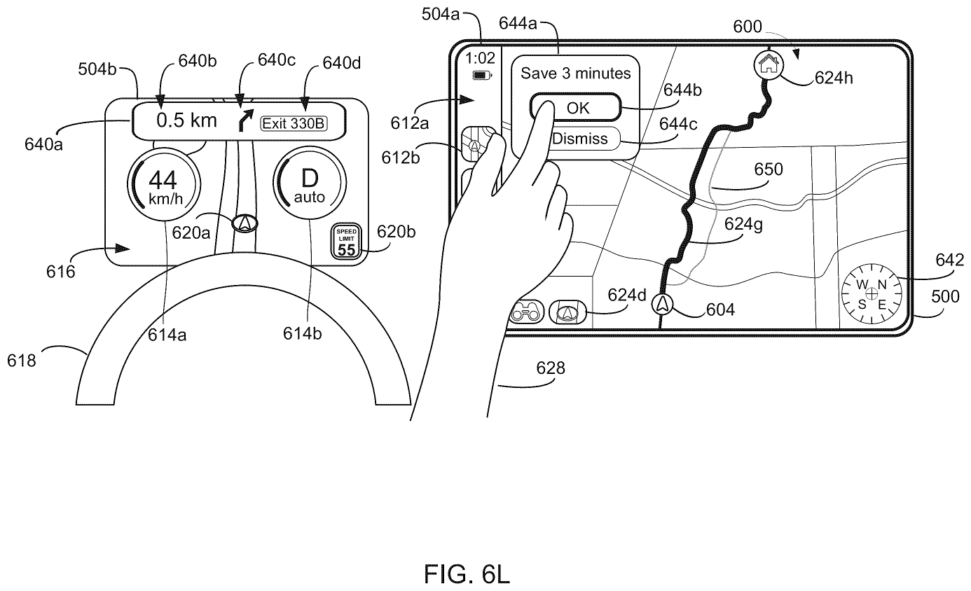

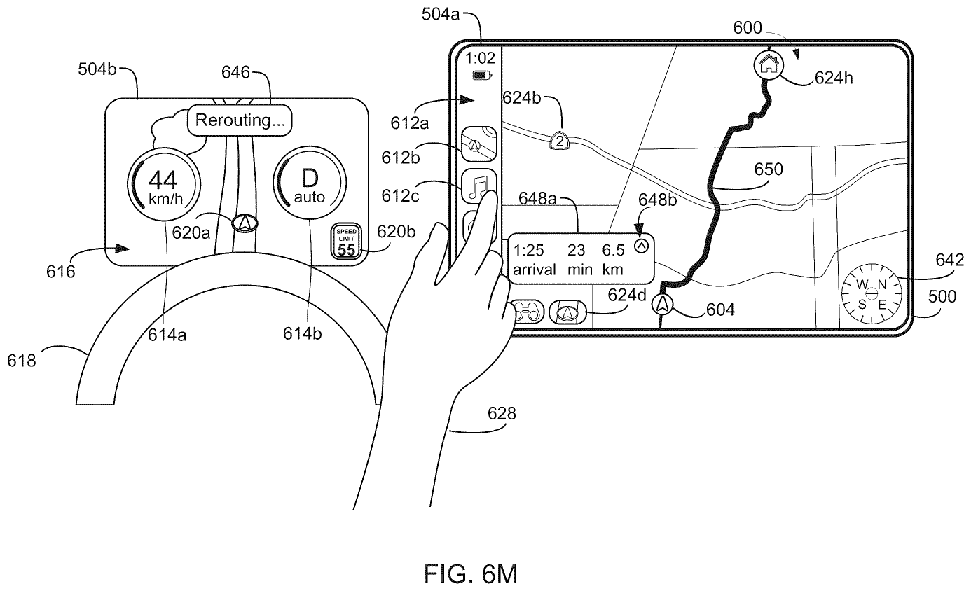

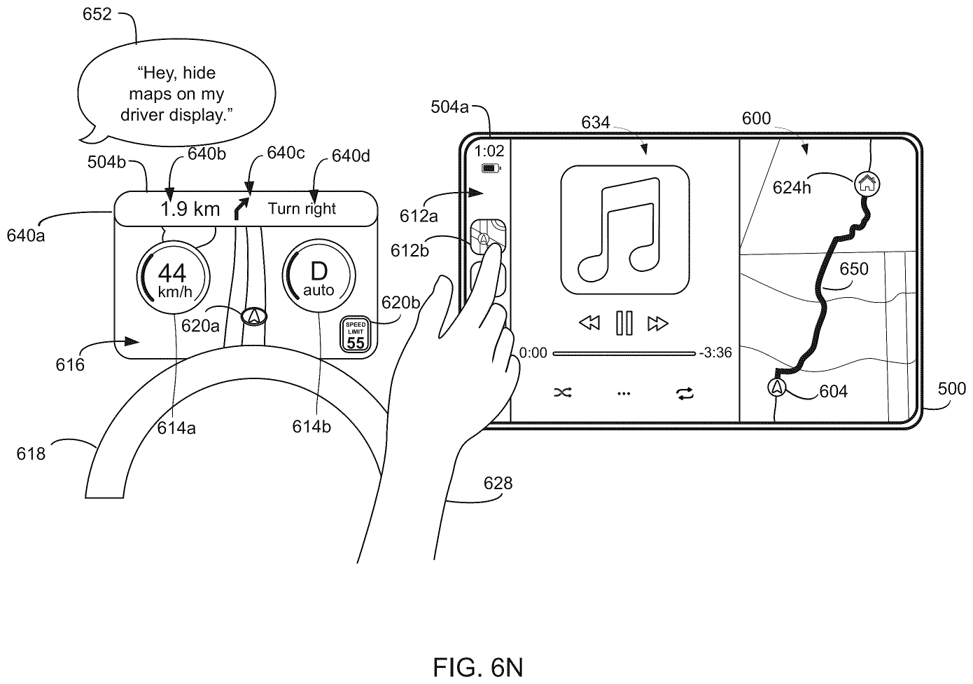

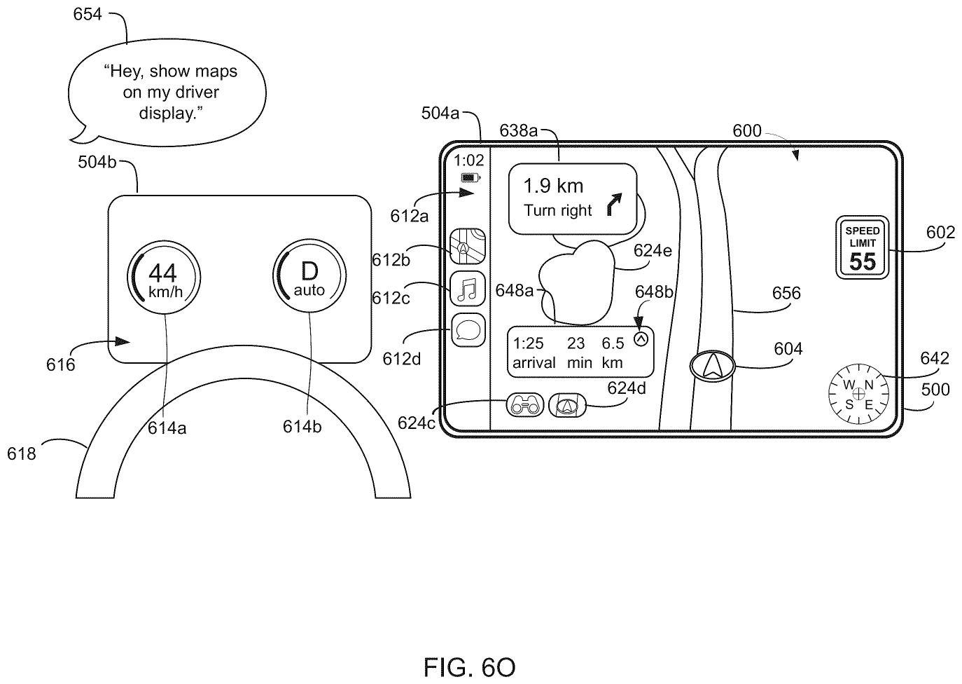

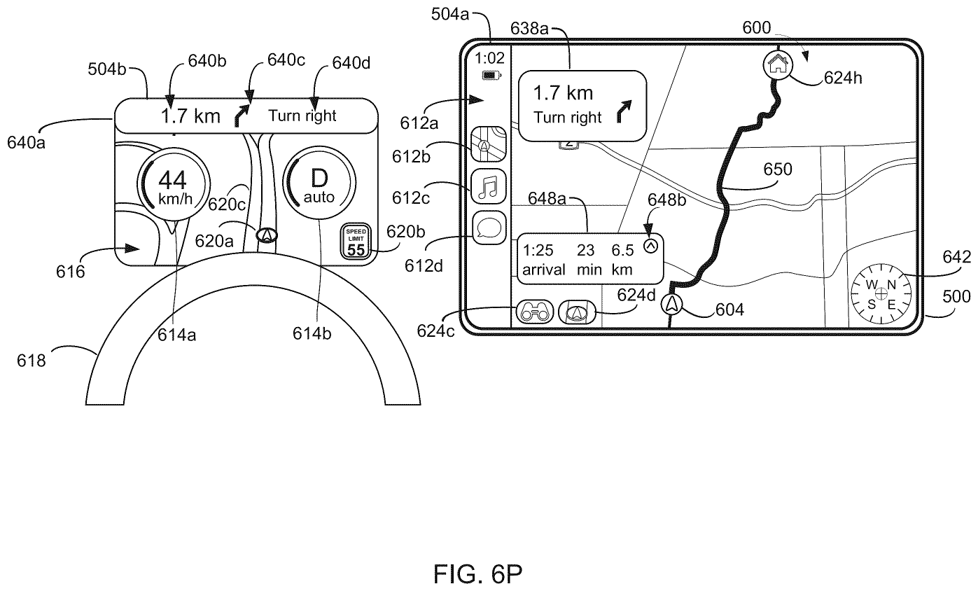

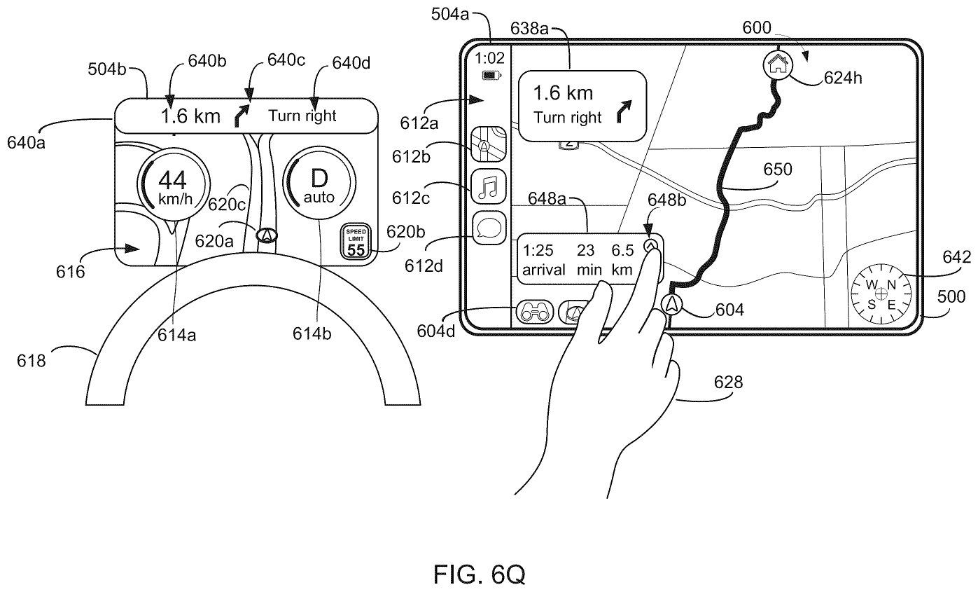

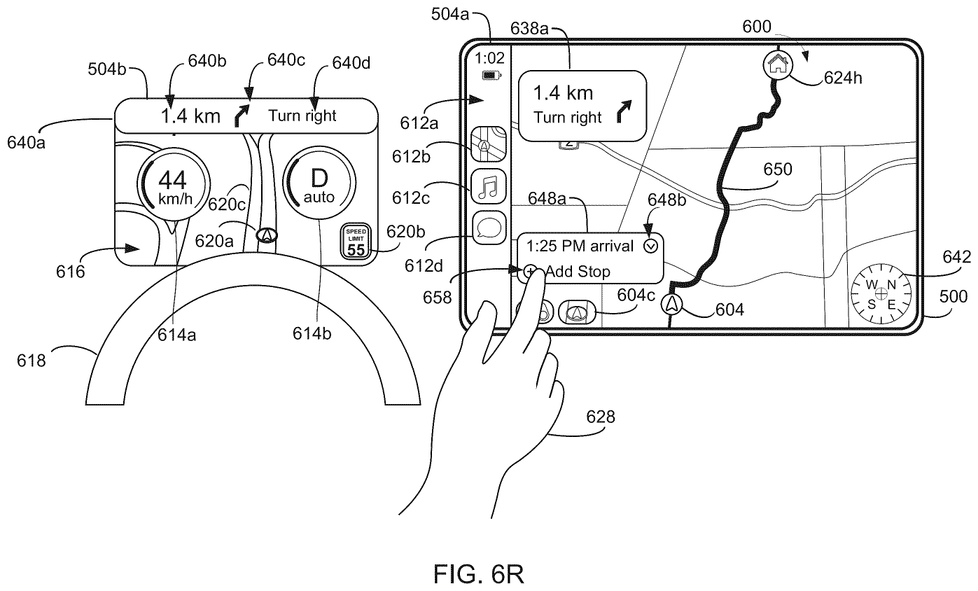

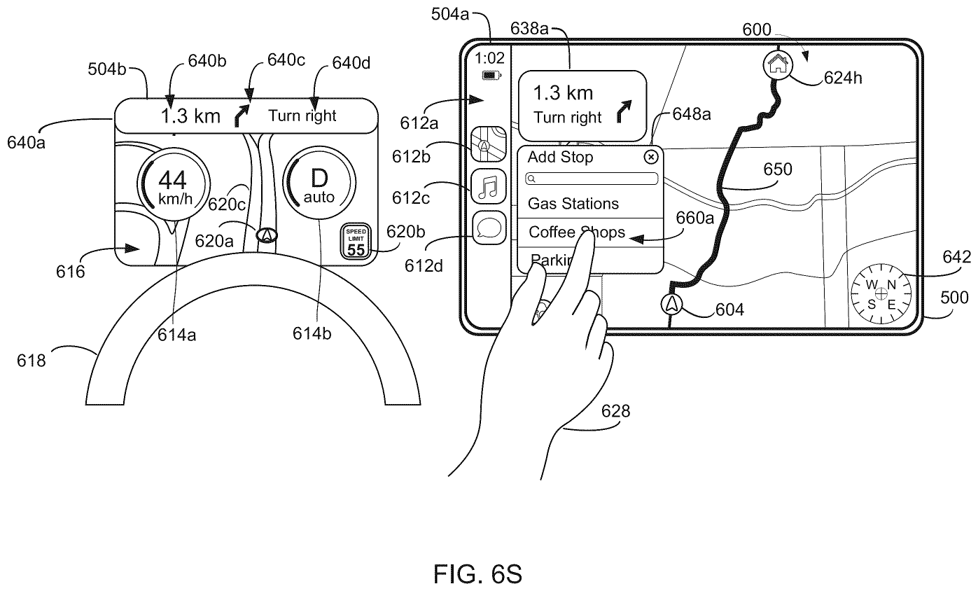

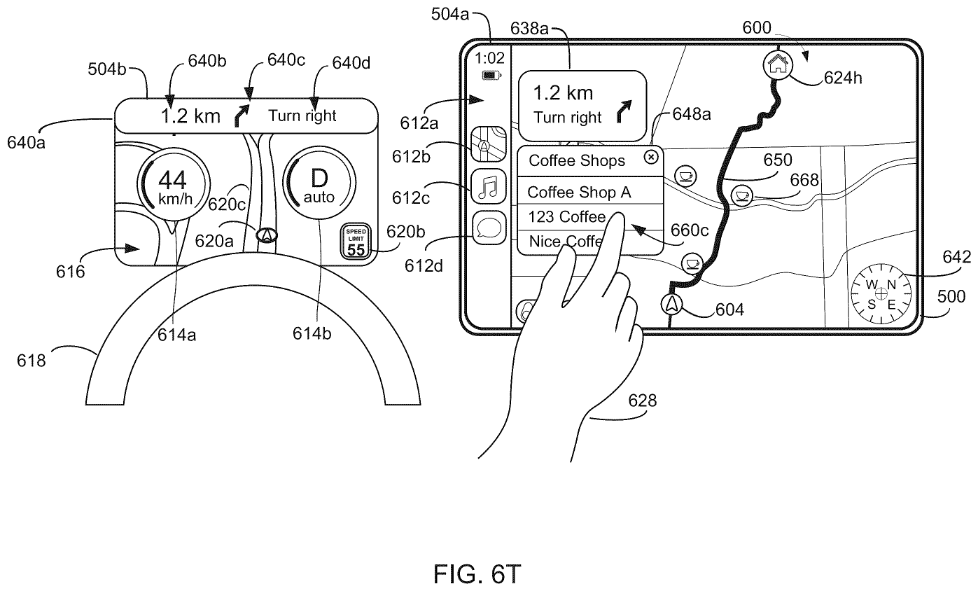

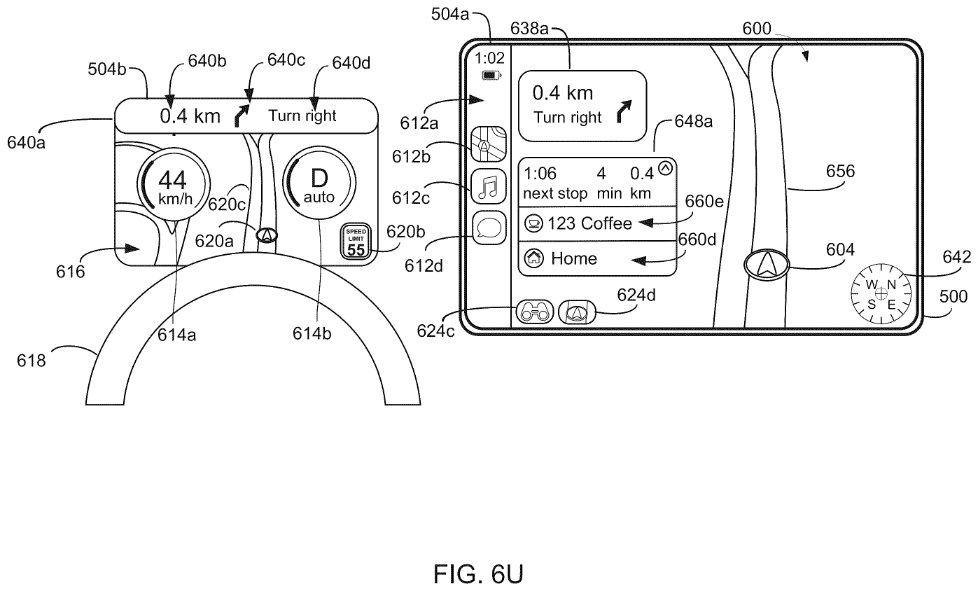

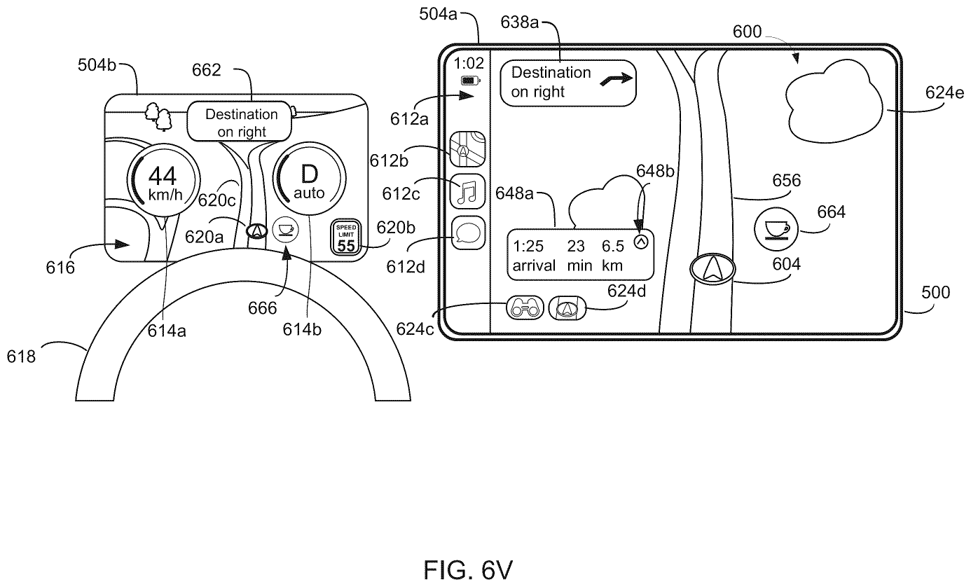

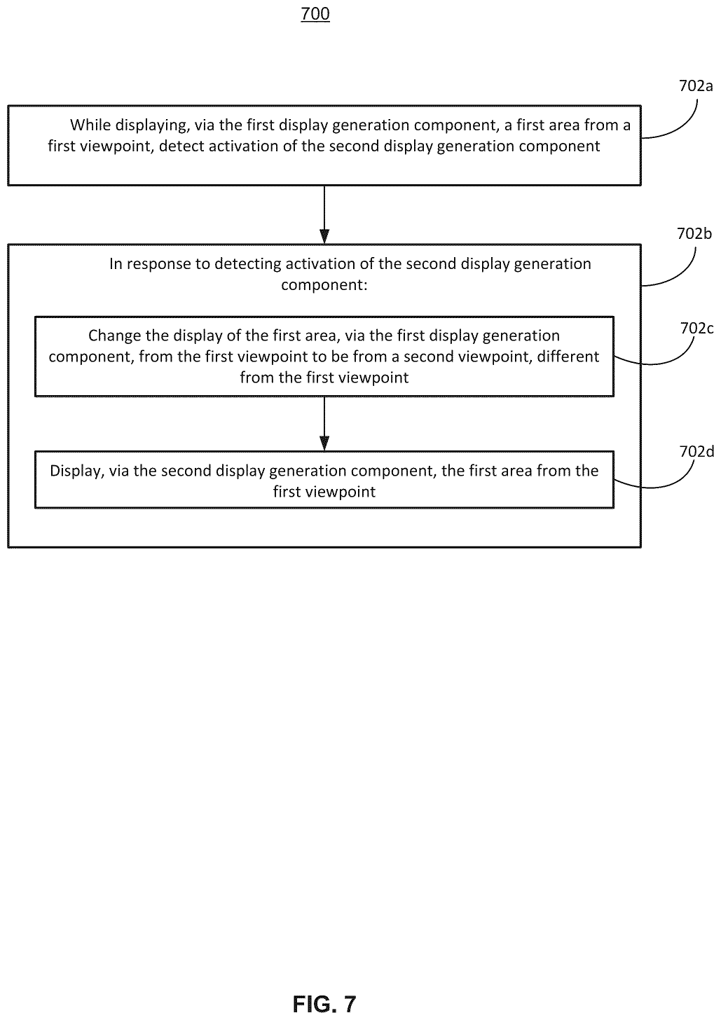

FIGS. 6A-6V illustrate exemplary ways in which an electronic device 500 displays a map of an area from different viewpoints within a map user interface of a map application. In some embodiments, the electronic device displays a geographic area or another type of area, such as a topographic area or a nautical area. The embodiments in these figures are used to illustrate the processes described below, including the processes described with reference to FIG. 7. Although FIGS. 6A-6V illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6V.

FIG. 6A illustrates a first display generation component 504a and a second display generation component 504b. In some embodiments, the first display generation component 504a and the second display generation component 504b component are hardware components (e.g., including electrical components) capable of receiving display data and displaying a user interface. In some embodiments, examples of the first display generation component 504a and the second display generation component 504b include a touch screen display, a monitor, a television, a projector, an integrated, discrete, or external display device, or any other suitable display device that is in communication with an electronic device 500 (e.g., electronic device of FIG. 5B). In some embodiments, the first display generation component 504a and the second display generation component 504b component include one or more of the features described with reference to method 700.

In some embodiments, an electronic device (e.g., electronic device 500) can include a map application. For example, the map application can present maps, navigation routes, location metadata, and/or imagery (e.g., captured photos) associated with various geographical locations, points of interest, etc. The map application can obtain map data that includes data defining maps, map objects, navigation routes, points of interest, imagery, etc., from a server. For example, the map data can be received as map tiles that include map data for geographical areas corresponding to the respective map tiles. The map data can include, among other things, data defining roads and/or road segments, metadata for points of interest and other locations, three-dimensional models of the buildings, infrastructure, and other objects found at the various locations, and/or images captured at the various locations. The map application can request, from the server through a network (e.g., local area network, cellular data network, wireless network, the Internet, wide area network, etc.), map data (e.g., map tiles) associated with locations that the electronic device frequently visits. The map application can store the map data in a map database. The map application can use the map data stored in map database and/or other map data received from the server to provide the maps application features described herein (e.g., navigation routes, maps, navigation route previews, etc.).

In some embodiments, the electronic device 500 is in communication with a system, such as a vehicle information and entertainment system (e.g., infotainment system) and/or a vehicle dashboard/instrument cluster system. In some embodiments, the electronic device 500 can be a computing device, or multiple computing devices, configured to store, generate, and/or provide map data to various user devices and/or the vehicle systems, as described herein. For example, the functionality described herein with reference to the electronic device 500 can be performed by a single computing device or can be distributed amongst multiple computing devices.

As shown in FIG. 6A, the electronic device 500 presents a map user interface 600 (e.g., of a map application installed on electronic device 500) via the first display generation component 504a. In FIG. 6A, the map user interface 600 presents a map of a first geographic area from a first viewpoint. The first viewpoint optionally includes a simulated camera overhead view of the first geographic area. In some embodiments, the first viewpoint includes a simulated camera angle relative to the current location of electronic device 500 (e.g., representation 604). For example, the simulated camera is optionally positioned behind representation 604 corresponding to the current location of electronic device 500 such that the first viewpoint appears as captured by the simulated camera above and behind representation 604 as shown in FIG. 6A. In some embodiments and as will be described below, changing a zoom level of the first viewpoint adjusts the position including the angle of the simulated camera relative to representation 604. For example, the electronic device 500 initially configures the simulated camera angle relative to a normal or perpendicular to the map of the first geographic area and displaying the first geographic area from the first viewpoint includes a first simulated camera angle away from normal such as 5, 10, 15, 20, 30, 35, 40, or 45 degrees. In some embodiments, the first viewpoint includes one or more of the features described with reference to method 700. In some embodiments, the first geographic area from the first viewpoint includes representations of trees (e.g., representation 606 of FIG. 6A), parks, buildings, roads (e.g., representation 608), and/or highways (e.g., representation 610). Additional or alternative representations of additional or alternative map information and/or features are also contemplated and described with reference to method 700.

In some embodiments, the electronic device 500 presents additional information associated with the displayed map of the first geographic area from the first viewpoint. For example, and as shown in FIG. 6A, the first geographic area from the first viewpoint includes a representation of a current location 604 of the electronic device 500 on a road (e.g., representation 610); an indication 602 of the speed limit on the road on which the electronic device 500 is currently traveling; selectable user interface object 624c that, when selected, causes the electronic device 500 to zoom the map of the first geographic area; and selectable user interface object 624d that, when selected, causes the electronic device 500 to change the display of the first geographic area from a first viewpoint to be from a second viewpoint and vice versa as will be described and illustrated below.

In FIG. 6A, the map user interface 600 optionally includes user interface element 612a. The user interface element 612a includes one or more selectable user interface objects selectable to perform a respective operation. For example, in FIG. 6A, user interface element 612a optionally includes selectable user interface object 612b that, when selected, causes the electronic device 500 to display the map user interface 600; selectable user interface object 612c that, when selected, causes the electronic device 500 to display a music player user interface of a music application; and selectable user interface object 612d that, when selected, causes the electronic device 500 to display a messaging user interface of a messaging application. In some embodiments, the electronic device 500 detects user input (e.g., a gaze of the user, a contact on a touch-sensitive surface, actuation of a physical input device of the vehicle, a predefined gesture (e.g., pinch gesture or air tap gesture) and/or a voice input from the user) corresponding to selection of one of the selectable user interface objects 612b, 612c, or 612d, and in response, the electronic device displays a corresponding user interface described above. Additional or alternative selectable user interface objects and/or representations of additional or alternative application features are also contemplated and described with reference to method 700.

As will be described herein and shown in the following figures, electronic device 500 transitions or controls the transition of displaying the first geographic area, via the first display generation component 504a, from the first viewpoint as shown in FIG. 6A to be from a second viewpoint, different from the first viewpoint as shown in FIG. 6B and will be described below.

FIG. 6A also illustrates a second display generation component 504b to which the electronic device 500 is connected. In FIG. 6A, the second display generation component 504b is optionally illustrated as behind a steering wheel 618 of a driver seat in a vehicle. In contrast and in some embodiments, the first display generation component 504a is located in the center of the vehicle between the driver seat and a front passenger seat. The second display generation component 504b optionally displays user interface 616 of a dashboard/instrument cluster system of the vehicle. User interface 616 optionally includes a speedometer 614a and a tachometer 614b.

In some embodiments, the electronic device 500 detects user input (e.g., voice input 622 from the user as shown in FIG. 6A) corresponding to a request to display a map of the first geographic area via the second display generation component 504b. In response to the voice input 622 of FIG. 6A, and as shown in FIG. 6B, the electronic device 500 displays, via the second display generation component 504b, the map of the first geographic area from the first viewpoint without further user inputs to display the first geographic area from the first viewpoint. In some embodiments, the electronic device 500 detects user inputs other than voice input, such as a gaze of the user, a contact on a touch-sensitive surface, actuation of a physical input device of the vehicle, and/or a predefined gesture (e.g., pinch gesture or air tap gesture). FIG. 6B also illustrates that in response to the user input corresponding to the request to display the map of the first geographic area via the second display generation component 504b, the electronic device 500 changes the display of the first geographic area, via the first display generation component 504a, from the first viewpoint as show in FIG. 6A to be from a second viewpoint, as shown in FIG. 6B. Thus, in response to the input in FIG. 6A corresponding to a request to display the map using the second display generation component 504b, the electronic device 500 initiates display of the map from the first viewpoint using the second display generation component 504b and updates the viewpoint of the map displayed with the first display generation component 504a from the first viewpoint to the second viewpoint. In some embodiments, other user inputs described herein and with respect to method 700, other than voice input 622, corresponding to the request to the display the map of the first geographic area via the second display generation component 504b cause the electronic device to display the map of the first geographic area via the second display generation component 504b.

In some embodiments, the second viewpoint includes a simulated aerial view of the first geographic area. In some embodiments, the second viewpoint includes a simulated camera angle relative to the current location of electronic device 500 (e.g., representation 604 of FIG. 6B). For example, the simulated camera is optionally positioned above representation 604 corresponding to the current location of electronic device 500 such that the second viewpoint appears as captured by the simulated camera at a bird's eye view as shown in FIG. 6B. In some embodiments and as will be described below, changing a zoom level of the second viewpoint adjusts the position including the angle of the simulated camera relative to representation 604. For example, displaying the first geographic area from the second viewpoint includes a second simulated camera angle normal or perpendicular to the map of the first geographic area or away from normal such as 2, 5, 10, 15, 20, 30, or 35 degrees. In some embodiments, the second viewpoint includes one or more of the features described with reference to method 700. In some embodiments, the first geographic area from the second viewpoint includes representations of roads (e.g., representation 624f) and/or highways (e.g., representation 624b). In some embodiments, the electronic device 500 presents additional information associated with the displayed map of the first geographic area from the second viewpoint. For example, and as shown in FIG. 6B, the first geographic area from the second viewpoint includes a representation of a current location 604 of the electronic device 500 on a road (e.g., representation 624f) and a representation of a point of interest (e.g., representation 624h of the user's home) that was not previously displayed, via the first display generation component 504a, from the first viewpoint shown in FIG. 6A. Additional or alternative representations of additional or alternative map information and/or features are also contemplated and described with reference to method 700.

As mentioned above, in response to the voice input 622 of FIG. 6A, the electronic device 500 displays, via the second display generation component 504b, the map of the first geographic area from the first viewpoint, as shown in FIG. 6B. In some embodiments, the first geographic area from the first viewpoint displayed via the second display generation component 504b shown in FIG. 6B includes the same or different representations of map information and/or user interface elements as the first geographic area from the first viewpoint displayed via the first display generation component 504a shown in FIG. 6A. For example, the electronic device 500 controls the display of content via the second display generation component 504b such that the electronic device 500 optionally displays the map of the first geographic area from the first viewpoint concurrently with and/or overlaid upon user interface 616 of the dashboard/instrument cluster system of the vehicle as shown in FIG. 6B. For example, in FIG. 6B, the electronic device 500 continues to display speedometer 614a and a tachometer 614b while displaying the map of the first geographic are from the first viewpoint. In some embodiments, displaying, via the second display generation component 504b, the map of the first geographic area from the first viewpoint includes one or more of the features described with reference to method 700. In some embodiments, the first geographic area from the first viewpoint includes representations of trees (e.g., representation 620d), parks, buildings, roads, and/or highways (e.g., representation 620c).

In some embodiments, the electronic device 500 presents additional information associated with the displayed map of the first geographic area from the first viewpoint. For example, and as shown in FIG. 6B, the first geographic area from the first viewpoint displayed via the second display generation component 504b includes a representation of a current location 620a of the electronic device 500 on a road (e.g., representation 620c) and an indication 620b of the speed limit on the road on which the electronic device 500 is currently traveling. Additional or alternative representations of additional or alternative map information and/or features are also contemplated and described with reference to method 700. In some embodiments, one or more representations of map information and/or user interface elements displayed via the first display generation component 504a is no longer displayed when displaying the map of the first geographic area via the second display generation component 504b (e.g., the one or more representations of map information and/or user interface elements previously displayed via the first display generation component 504a is moved and displayed via the second display generation component 504b). For example, from FIG. 6A to FIG. 6B, the indication 620b of the speed limit on the road on which the electronic device 500 is currently traveling shown in FIG. 6A is no longer displayed via the first display generation component 504a in FIG. 6B, and is now displayed by the second display generation component 504b (e.g., indication 620b).

In some embodiments, although the first geographic area from the first viewpoint displayed via the second display generation component 504b in FIG. 6B does not include selectable user interface object 624d described herein, the electronic device 500 is configured to detect other user inputs corresponding to the request to change the displayed viewpoint and is configured to change the display of the first geographic area from a first viewpoint to be from a second viewpoint and vice versa. For example, in FIG. 6B, the electronic device 500 detects voice input 624 from the user corresponding to a request to switch the display of the first geographic area via the second display generation component 504b from the first viewpoint to be from the second viewpoint. Additionally or alternatively, in some embodiments, the electronic device 500 detects gesture-based inputs (e.g., motion of the user's hand(s), arm(s), finger(s), head, and/or torso).

In response to the voice input 624 of FIG. 6B, and as shown in FIG. 6C, the electronic device 500 displays, via the second display generation component 504b, the map of the first geographic area from the second viewpoint. In FIG. 6C, the electronic device 500 displays the first geographic area from the second viewpoint via both the first display generation component 504a and the second display generation component 504b. In some embodiments, displaying the first geographic area from the second viewpoint via the second display generation component 504b includes displaying representations of map information and/or user interface elements that are the same as the representations of map information and/or user interface elements included while displaying the first geographic area from the second viewpoint via the first display generation component 504a. In some embodiments, displaying the first geographic area from the second viewpoint via the second display generation component 504b includes displaying representations of map information and/or user interface elements that are different from the representations of map information and/or user interface elements included while displaying the first geographic area from the second viewpoint via the first display generation component 504a. For example, the electronic device 500 optionally displays, via the second display generation component 504b, the map of the first geographic area from the second viewpoint including an indication 620b of the speed limit on the road on which the electronic device 500 is currently traveling, a representation of a current location 620a of the electronic device 500 on a road, and a representation 620f of Highway Two. In some embodiments, one or more representations of map information and/or user interface elements included with displaying the first geographic area from the second viewpoint via the second display generation component 504b are the same as the one or more representations of map information and/or user interface elements included with displaying the first geographic area from the first viewpoint via the second display generation component 504b. For example, from FIG. 6B to FIG. 6C, the electronic device 500 displays the first geographic area, via the second display generation component 504b, including the indication 620b of the speed limit on the road on which the electronic device 500 is currently traveling.

In FIG. 6C, the electronic device 500 optionally also displays, via the first display generation component 504a, from the second viewpoint a representation of a current location of the electronic device 500 on a road (e.g., representation 604) and a representation of Highway Two (e.g., representation 624b). In FIG. 6C, the electronic device 500 optionally additionally displays a point of interest corresponding to the user's home (e.g., representation 624h) that is not included in the map of the first geographic area from the second viewpoint, displayed via the second display generation component 504b. In some embodiments, the first geographic area from the second viewpoint displayed via the first display generation component 504a includes a portion of the map of the first geographic area including representation 624h, that is larger than the portion of the map of the first geographic area from the second viewpoint displayed via the second display generation component 504b.

In some embodiments, the electronic device 500 does not include selectable user interface object 624c in the map of the first geographic area from the second viewpoint via the second display generation component 504b, but displays selectable user interface object 624c via the first display generation component 504a and as described herein. In some embodiments, the electronic device 500 is configured to detect other user inputs corresponding to the request to zoom the map of the first geographic area displayed via the second display generation component 504b. For example, in FIG. 6C, the electronic device 500 detects voice input 626 from the user corresponding to a request to zoom the map of the first geographic area displayed via the second display generation component 504b.

In response to receiving the voice input 626 of FIG. 6C, and as shown in FIG. 6D, the electronic device 500 displays, via the second display generation component 504b, the map of the first geographic area at a zoom level corresponding to the first viewpoint. For example, in FIG. 6D, the first geographic area at the zoom level corresponding to the first viewpoint includes the same representations of map information and/or user interface elements as the first geographic area from the first viewpoint displayed via the second display generation component 504b shown in FIG. 6B. In some embodiments, the electronic device 500 displays the map of the first geographic area at a zoom level different from a zoom level associated with the first viewpoint as described with reference to method 700 in response to an input corresponding to a request to zoom in on the map. For example, and as will be described in more detail with respect to FIG. 6V, displaying the first geographic area at the different zoom level from the zoom level associated with the first viewpoint includes optionally displaying the map of the first geographic area with more detail than a level of detail of the first viewpoint. As another example, displaying the first geographic area at the different zoom level from the zoom level associated with the first viewpoint includes optionally displaying a map of a smaller geographic area than the geographic area included in the first viewpoint.

In FIG. 6D, the electronic device 500 detects a user input (e.g., finger of hand 628 directed to selectable user interface object 624d) corresponding to a request to change the display of the first geographic area, via the first display generation component 504a, from the second viewpoint to be from the first viewpoint. In response to the user input directed to selectable user interface object 624d in FIG. 6D, and as shown in FIG. 6E, the electronic device 500 changes display of the first geographic area, via the first display generation component 504a, from the second viewpoint shown in FIG. 6D to be from the first viewpoint shown in FIG. 6E. In some embodiments, other user inputs described herein and with respect to method 700, other than the use input illustrated and described in FIG. 6D, corresponding to the request to change the display of the first geographic area, via the first display generation component 504a, from the second viewpoint to be from the first viewpoint cause the electronic device to change the display of the first geographic area, via the first display generation component 504a, from the second viewpoint to be from the first viewpoint or vice versa. Similarly, in some embodiments, the electronic device 500 updates the display of the map via the first display generation component 504a from the first viewpoint to be from the second viewpoint in response to other types of inputs received while displaying the map from the first viewpoint using the first display generation component 504a.

In some embodiments, while displaying the first geographic area from the first viewpoint via the first display generation component 504a, the electronic device 500 detects a user input directed to selectable user interface object 624d of FIG. 6D, and in response, the electronic device 500 changes the display of the first geographic area, via the first display generation component 504a, from the first viewpoint shown in FIG. 6E to be from the second viewpoint shown in FIG. 6D.

In some embodiments, displaying the map from the first viewpoint using the first display generation component 504a shown in FIG. 6E includes the first geographic area displayed at a level of zoom that is zoomed in on a portion of the road that includes the current location of electronic device 500 (e.g., representation 604) as described above with reference to the first display generation component 504a in FIG. 6A. In some embodiments, in response to detecting user input directed to selectable user interface object 624d of FIG. 6D, the electronic device 500 does not change the display of the map via the second display generation component 504b from the first viewpoint as shown in FIG. 6E.

In FIG. 6E, the electronic device 500 detects a user input (e.g., finger of hand 628 directed to selectable user interface object 624c) corresponding to a request to zoom the map of the first geographic area displayed via the first display generation component 504a. In response to the user input directed to selectable user interface object 624c in FIG. 6E, and as shown in FIG. 6F, the electronic device 500 changes the zoom level of the first viewpoint to be from a different zoom level (e.g., greater or less than an amount of zoom associated with the first viewpoint before detecting the user input). In some embodiments, the different level of zoom of the first viewpoint is optionally a level of zoom at which foliage (representation 624e), sidewalks, bike lanes, medians, lanes of roads, and/or cross walks are displayed. In some embodiments, the different zoom level includes representations of map information at a greater level of detail than the zoom level of the first viewpoint as described in method 700. As another example, displaying the first geographic area at the different zoom level from the zoom level associated with the first viewpoint includes optionally displaying a map of a smaller geographic area than the geographic area included in the first viewpoint before detecting the user input. In some embodiments, other user inputs described herein and with respect to method 700, other than the input in FIG. 6E, corresponding to the request to zoom the map of the first geographic area causes the electronic device to zoom the map of the first geographic area.

FIG. 6F also illustrates that in response to the user input corresponding to the request to zoom the map of the first geographic area, the electronic device 500 changes the display of the first geographic area, via the second display generation component 504b, from the first viewpoint as show in FIG. 6E to be from the second viewpoint, as shown in FIG. 6F. Thus, in response to the input in FIG. 6E corresponding to a request to zoom the map of the first geographic area using the first display generation component 504a, the electronic device 500 initiates display of the map from the first viewpoint using the first display generation component 504a and updates the viewpoint of the map displayed with the second display generation component 504b from the first viewpoint to the second viewpoint.

In FIG. 6F, the electronic device 500 detects a user input (e.g., voice input 630 from the user) corresponding to a request to zoom the map of the first geographic area displayed via the second display generation component 504b. In response to the voice input 630 of FIG. 6F, and as shown in FIG. 6G, the electronic device 500 displays, via the second display generation component 504b, the map of the first geographic area from the first viewpoint, which is zoomed in from the viewpoint of the map displayed by the second display generation component 504b in FIG. 6F. FIG. 6G also illustrates that in response to the user input corresponding to the request to zoom the map of the first geographic area via the second display generation component 504b, the electronic device 500 optionally changes the display of the first geographic area, via the first display generation component 504a, from the first viewpoint as show in FIG. 6F to be from a second viewpoint, as shown in FIG. 6G, which corresponds to zooming the map displayed by the first display generation component 504a out from FIG. 6F to FIG. 6G. Thus, in response to the input in FIG. 6F corresponding to a request to zoom the map of the first geographic area, the electronic device 500 updates the viewpoint of the map, displayed via the second display generation component 504b, from the second viewpoint to be from the first viewpoint and updates the viewpoint of the map, displayed via the first display generation component 504a, from the first viewpoint to be from the second viewpoint.

In some embodiments, the electronic device 500 displays a user interface other than the map user interface 600. For example, in FIG. 6H, the electronic device 500 detects a user input (e.g., finger of hand 628 directed to selectable user interface object 612c) corresponding to a request to display a music player user interface of a music application via the first display generation component 504a. In response to the user input directed to selectable user interface object 612c, and as shown in FIG. 6I, the electronic device 500 initiates display of music player user interface 634 of a music application via the first display generation component 504a and ceases display of the map user interface 600 using the first display generation component 504a. In some embodiments, ceasing to display the map user interface 600 via the first display generation component 504a and/or initiating display of the music player user interface of the music application via the first display generation component 504a does not cause a change to the map of the first geographic area displayed via the second display generation component 504b (e.g., does not cause ceasing to display the map of the first geographic area via the second display generation component 504b). Thus, in FIG. 6I, the electronic device 500 maintains display of the first geographic area from the first viewpoint via the second display generation component 504b.

In some embodiments and as illustrated in FIG. 6I, the electronic device 500 detects a user input (e.g., voice input 632 from the user) corresponding to a request to display the map user interface 600 via the first display generation component 504a. In some embodiments, in response to the voice input 632 of FIG. 6I, and as shown in FIG. 6J, the electronic device 500 displays, via the first display generation component 504a, the map user interface 600 including a map of the first geographic area from the second viewpoint. In some embodiments, and as described in more detail with reference to method 700, when one display generation component (e.g., the first display generation component 504a or the second display generation component 504b) presents a map of a geographic area from a first viewpoint, the electronic device 500 initiates display of the map from a second viewpoint in response to detecting activation of a second display generation component. For example, in FIG. 6J, the second display generation component 504b presents the first geographic area from the first viewpoint and the first display generation component 504a presents the first geographic area from the second viewpoint in response to activation of two display generation components (without further user inputs to select the first viewpoint and/or the second viewpoint).

In some embodiments, the electronic device displays maps of geographic areas from different viewpoints while navigating along a route. For example, in FIG. 6J, the electronic device 500 detects a user input (e.g., voice input 636 from the user) corresponding to a request to initiate navigation directions to home (e.g., representation 624h). In response to the voice input 636 of FIG. 6J, and as shown in FIG. 6K, the electronic device 500 displays, via the first display generation component 504a and the second display generation component 504b, respective maps of the first geographic area from the respective viewpoints including respective user interface elements associated with navigating along a route to home.

In some embodiments, the electronic device 500 presents navigation directions from a first location (e.g., representation 604) to home (representation 624h). In some embodiments, and as will be shown in FIG. 6K, presenting the navigation directions includes presenting a representation of the route line and one or more representations of physical objects in the physical vicinity of the route line. The following figures illustrate examples in which the electronic device 500 presents the map including navigation routes and instructions from different viewpoints. In FIG. 6K, the electronic device 500 displays the first geographic area, via the first display generation component 504a, from the second viewpoint including a representation 638a of an upcoming maneuver, an indication 624g of the route, the current location of electronic device 500 (e.g., representation 604), an indication of an estimated time of arrival at the destination (e.g., representation 648a), and a compass user interface element 642 that presents cardinal directions to orient the user. In some embodiments and as illustrated in FIG. 6K, the representation 638a of the upcoming maneuver includes a description of and/or icon illustrating the maneuver type (e.g., representation 638b), a location of the upcoming maneuver (e.g., representation 638c), a distance between the location of the electronic device and the location of the maneuver (e.g., representation 638d), and/or a location of the destination (e.g., representation 638e).

In some embodiments, the electronic device 500 displays the first geographic area, via the second display generation component 504b, from the second viewpoint including a representation 640a of an upcoming maneuver similar to the representation 638a of the upcoming maneuver presented via the first display generation component 504a. For example and as shown in FIG. 6K, representation 640a includes an icon illustrating the maneuver type (e.g., representation 640c), a location of the upcoming maneuver (e.g., representation 640d), a distance between the location of the electronic device and the location of the maneuver (e.g., representation 640b), but does not include displaying, via the second display generation component 504b, the location of the destination that is presented by the first display generation component 504a (e.g., representation 638e). In some embodiments, displaying the first geographic area, via the first display generation component 504a, includes user interface elements not included when displaying the first geographic area, via the second display generation component 504b, such as the indication of the estimated time of arrival at the destination (e.g., representation 624h), and the compass user interface element 642. Additional or alternative representations of additional or alternative map information and/or features are also contemplated and described with reference to method 700.

In some embodiments, the electronic device 500 changes the viewpoint and/or a zoom level of the viewpoint presented via the display generation component (e.g., the first display generation component 504a and/or the second display generation component 504b) in response to the electronic device 500 detecting an upcoming route characteristic as described with reference to method 700 (e.g., traffic congestion, detours, alternative routes, road closings, hazardous conditions, construction, and/or traffic accidents along the route). In some embodiments, the electronic device 500 changes the viewpoint and/or a zoom level of the viewpoint presented via the display generation component such that the map area associated with the upcoming route characteristic and/or an entirety of the route associated with the upcoming route characteristic is displayed. For example, in FIG. 6L, the electronic device 500 detects that an alternative route satisfies one or more criteria described with reference to method 700, and in response, the electronic device 500 optionally displays the first geographic area, via the first display generation component 504a, from the second viewpoint including an indication 650 of the alternative route and a notification 644a including a description of an amount of potential time saved by taking the alternative route, an option 644b to accept navigating along the alternative route, and an option 644c to dismiss or decline navigating along the alternative route. In some embodiments, if the portion of the route to be changed is not included in the map when the electronic device 500 detects that the alternative route satisfies the one or more criteria, the electronic device 500 updates the portion of the map shown when displaying notification 644a. For example, the electronic device 500 pans the map and/or zooms the map out.

In FIG. 6L, the electronic device 500 detects a user input (e.g., finger of hand 628 directed to option 644b), and in response to the user input, and as shown in FIG. 6M, the electronic device 500 initiates navigation along route the alternative route. In some embodiments, initiating navigation along the alternative route includes presenting notifications via the display generation component (e.g., the first display generation component 504a and/or the second display generation component 504b). For example, in FIG. 6M, the electronic device 500 displays the first geographic area, via the first display generation component 504a, from the second viewpoint including an indication of an estimated time of arrival at the destination (e.g., representation 648a) that is updated based on navigating along the alternative route and an indication 650 of the alternative route. Also illustrated in FIG. 6M, the electronic device 500 displays the first geographic area, via the second display generation component 504b, from the first viewpoint including a notification 646 of navigating along a different route from the route before detecting user input to accept navigating along the alternative route.

In some embodiments, the electronic device 500 displays a user interface other than the map user interface 600 concurrently with the map user interface 600. For example, in FIG. 6M, the electronic device 500 detects user input (e.g., finger of hand 628 directed to selectable user interface object 612c) corresponding to a request to display a music player user interface of a music application via the first display generation component 504a. In response to the user input directed to selectable user interface object 612c, and as shown in FIG. 6N, the electronic device 500 concurrently displays music player user interface 634 of a music application and the map user interface 600 including a map of the first geographic area from the second viewpoint via the first display generation component 504a. In some embodiments, when the electronic device displays both the music player user interface and the map user interface 600 via the first display generation component 504a, the electronic device 500 changes a size, an appearance, and/or the information displayed as described in more detail with reference to method 700. For example, from FIG. 6M to FIG. 6N, the electronic device 500 displays fewer representations of map information and/or user interface elements while displaying the music player user interface and the map user interface 600 via the first display generation component 504a concurrently than the number of representations of map information and/or user interface elements displayed when the music player user interface was not displayed. For example, in FIG. 6N, the map of the first geographic area from the second viewpoint does not include compass user interface element 642 and representation 648a displayed in FIG. 6M. Instead, the map of the first geographic area from the second viewpoint includes an indication 650 of the navigation route, the current location of electronic device 500 (e.g., representation 604), and the destination (e.g., representation 624h). Although the map of the first geographic area does not include a representation of an upcoming maneuver that was previously displayed before initiating concurrent display of the music player user interface and the map user interface 600 via the first display generation component 504a, the electronic device displays the first geographic area, via the second display generation component 504b, from the first viewpoint including a representation 640a of an upcoming maneuver as described herein.

In some embodiments and as illustrated in FIG. 6N, the electronic device 500 detects a user input (e.g., voice input 652 from the user) corresponding to a request to hide or cease displaying the map of the first geographic area via the second display generation component 504b. In some embodiments, in response to the voice input 652 of FIG. 6N, and as shown in FIG. 6O, the electronic device 500 ceases to display the map of the first geographic area via the second display generation component 504b and ceases to display the music player user interface with the first display generation component 504a. The electronic device 500 optionally maintains display of speedometer 614a and tachometer 614b with the second display generation component 504b. In some embodiments, the electronic device 500 displays, via the first display generation component 504a, the map of the first geographic area from the first viewpoint without displaying the music player user interface. In some embodiments, in response to the input in FIG. 6N, the electronic device 500 continues to display music player user interface 634 concurrently with the map of the first geographic area from the first viewpoint similarly to FIG. 6N although from the first viewpoint and ceases to display the map using the second display generation component 504b as shown in FIG. 6O.

In FIG. 6O, the electronic device 500 displays the map of the first geographic area, via the first display generation component 504a, from the first viewpoint including a representation 638a of an upcoming maneuver included in the navigation directions, the current location of electronic device 500 (e.g., representation 604) along route 656, an indication of an estimated time of arrival at the destination (e.g., representation 648a), a compass user interface element 642 that presents cardinal directions to orient the user, and an indication 602 of the speed limit on the road on which the electronic device 500 is currently traveling. Additional or alternative representations of additional or alternative map information and/or features are also contemplated and described with reference to method 700. Thus, in response to the input in FIG. 6N corresponding to a request to hide or cease displaying the map of the first geographic area via the second display generation component 504b, the electronic device 500 updates the viewpoint of the map displayed with the first display generation component 504a from the second viewpoint to the first viewpoint and ceases display of the map via the second display generation component 504b.

FIG. 6O also illustrates the electronic device 500 detecting a user input (e.g., voice input 654 from the user) corresponding to a request to display the map of the first geographic area via the second display generation component 504b. In some embodiments, in response to receiving the voice input 654 of FIG. 6O, and as shown in FIG. 6P, the electronic device 500 displays the map of the first geographic area via the second display generation component 504b from the first viewpoint. As shown in FIG. 6P, displaying the map with the second display generation component 504b includes displaying a representation 640a of an upcoming maneuver as previously described with reference to FIG. 6K, the speedometer 614a and tachometer 614b. Additionally, in some embodiments, in response to the input illustrated in FIG. 6O, the electronic device 500 changes the display of the first geographic area, via the first display generation component 504a, from the first viewpoint to be from the second viewpoint including the representations of map information and user interface elements described above with reference to FIG. 6K. Thus, in response to the input in FIG. 6O corresponding to a request to display the map of the first geographic area via the second display generation component 504b, the electronic device 500 updates the viewpoint of the map displayed with the first display generation component 504a from the first viewpoint to the second viewpoint.

In some embodiments, the electronic device 500 detects a sequence of inputs that correspond to a request to add a stop (e.g., destination) along the navigation route. For example, in FIG. 6Q, the electronic device 500 detects user input (e.g., finger of hand 628 directed to selectable user interface object 648b). In some embodiments, in response to receiving the input shown in FIG. 6Q, the electronic device 500 displays selectable user interface object 658 shown in FIG. 6R that, when selected, causes the electronic device 500 to initiate adding a stop along the route 650. In FIG. 6R, the electronic device 500 detects a user input (e.g., finger of hand 628 directed to selectable user interface object 658). In some embodiments, in response to receiving the input illustrated in FIG. 6R, the electronic device 500 displays options, including option 660a, corresponding to categories of stop locations that can be added to the navigation route, such as gas stations, coffee shops (e.g., option 660a), and/or parking lot rest areas as shown in FIG. 6S. In some embodiments, the options, including option 660a, are selectable to cause the electronic device 500 to search for and display representations of locations corresponding to the selected category. For example, in FIG. 6S, the electronic device 500 detects a user input (e.g., finger of hand 628 directed to option 660a). In some embodiments, in response to the input illustrated in FIG. 6S, the electronic device 500 displays a list of coffee shops (e.g., representation 660c), as shown in FIG. 6T. In some embodiments, in response to receiving an input directed to representation 660c, the electronic device 500 to adds the particular coffee shop to the navigation route. In some embodiments, as shown in FIG. 6T, in addition to the list of coffee shops, the electronic device 500 displays, with the first display generation component 504a, representations 668 corresponding to the plurality of coffee shops within (e.g., overlaid) the map of the first geographic area at locations corresponding to the locations of the coffee shops in the first geographic area.

In some embodiments, the electronic device 500 detects a user input (e.g., finger of hand 628 directed to a particular coffee shop (e.g., representation 660c)), as shown in FIG. 6T. In some embodiments, in response to the user input illustrated in FIG. 6T, the electronic device 500 adds the coffee shop to the route and updates the user interface as shown in FIG. 6U. For example, the electronic device 500 updates the display of representation 648a to include an estimated time of arrival at the stop and an indication of an order of stops along the route, such as the coffee shop (e.g., representation 660e) and home (e.g., representation 660d) as shown in FIG. 6U.

In some embodiments, during the process of adding the stop, the electronic device 500 displays the map of the first geographic area, via the first display generation component 504a, from the second viewpoint as shown in FIGS. 6Q-6T. In some embodiments, after adding the stop, the electronic device 500 changes the display of the map of the first geographic area, via the first display generation component 504a, from the second viewpoint to be from the first viewpoint as shown in FIG. 6U without further inputs from the user to change from the second viewpoint to the first viewpoint.

In some embodiments, the electronic device 500 detects arrival at the first stop, and in response, the electronic device 500 changes the display of the map of the first geographic area, via the first display generation component 504a, from the first viewpoint to be from a different zoom level of the first viewpoint as described with reference to method 700. For example, in FIG. 6V, the zoom level of the first viewpoint of the first display generation component 504a is a level of greater detail than the zoom level before detecting arrival at the first stop without further inputs from the user to change from the zoom level. For example, in FIG. 6V, the electronic device 500 displays, using the first display generation component 504a, foliage (e.g., representation 624e), a representation of the first stop corresponding to a building (e.g., representation 664), sidewalks, bike lanes, medians, lanes of roads, and/or cross walks. In some embodiments, displaying the map of the first geographic area from the first viewpoint with the first display generation component 504a differs from displaying the map of the first geographic area from the first viewpoint with the second display generation component 504b. In some embodiments, displaying the map of the first geographic area via the first display generation component 504a from the first viewpoint includes a zoom level with greater detail than the zoom level associated with displaying the map of the first geographic area via the second display generation component 504b. For example, in FIG. 6V, the representation of the first stop corresponding to a building of the first display generation component 504a includes a three-dimensional representation of the building (e.g., representation 664) while the representation of the first stop of the second display generation component 504b includes a two-dimensional representation of the building (e.g., representation 666). In some embodiments, the electronic device 500 presents different notifications of arrival at the first stop with the first display generation component 504a and the second display generation component 504b. For example, in FIG. 6V, the electronic device displays, via the first display generation component 504a, representation of notification 638a that includes a description of and/or icon illustrating the location of the stop. In contrast, the electronic device displays, via the second display generation component 504b, notification 662 that includes a description of the location of the stop without including an icon illustrating the location of the stop. Additional or alternative representations of additional or alternative map information and/or features are also contemplated and described with reference to method 700.

FIG. 7 is a flow diagram illustrating a method in which an electronic device displays a map of a geographic area from different viewpoints within a map user interface of a map application. In some embodiments, method 700 is performed at an electronic device (e.g., 500) in communication with a first display generation component (e.g., 504a), a second display generation component (e.g., 504b), and one or more input devices. In some embodiments, the electronic device is a mobile device (e.g., a tablet, a smartphone, a media player, or a wearable device), a vehicle information and entertainment system (e.g., infotainment system), a computer (e.g., a desktop computer, a laptop computer), and/or other electronic device. In some embodiments, the first and/or second display generation component is a display integrated with the electronic device (optionally a touch screen display), external display (e.g., vehicle infotainment displays, monitors, projectors, televisions, or hardware components (optionally integrated or external) for projecting user interfaces or causing a user interfaces to be visible to one or more users. In some embodiments, the first display generation component and the second display generation component correspond to vehicle infotainment displays. In some embodiments, the first display generation component is different from the second display generation component. For example, the first display generation component is optionally larger or smaller than the second display generation component. In some embodiments, the first display generation component is optionally a touch screen and the second display generation component is optionally a non-touch screen. In some embodiments, the first display generation component is located in the center of the vehicle (e.g., center display) between the driver seat and the front passenger seat. In some embodiments, the second display generation component is displayed behind the wheel (e.g., dashboard/instrument cluster or driver display) of the driver seat. In some embodiments, the electronic device is in communication with the first display generation component and the second display generation component using wired or wireless communication. In some embodiments, and as will be described herein, the electronic device provides content to the first and/or second display generation component. For example, the electronic device optionally provides the content and/or information to the second display generation component that defines a representation or visual appearance of a vehicle dashboard/instrument cluster system for display, via the second display generation component, as a respective user interface of the vehicle dashboard/instrument cluster system. In some embodiments, and as will be described herein with respect to method 700, the electronic device detects activation of a respective display generation component, and in response initiate display of or control display of content via the respective display generation component. In some embodiments, the one or more input devices include a computer system or component capable of receiving a user input (e.g., capturing a user input and/or detecting a user input) and transmitting information associated with the user input to the electronic device and/or vehicle infotainment system. Examples of input devices include physical buttons, knobs, handles, and/or switches of a vehicle, a touch screen, mouse (e.g., external), trackpad (optionally integrated or external), touchpad (optionally integrated or external), microphone for capturing voice commands or other audio input, remote control device (e.g., external), another electronic device (e.g., mobile device that is separate from the electronic device), a handheld device (e.g., external), a controller (e.g., external), a camera, a depth sensor, an eye tracking device, and/or a motion sensor (e.g., a hand tracking device, a hand motion sensor). In some embodiments, method 700 is performed at or by a vehicle (e.g., at an infotainment system of an automobile having or in communication with one or more display generation components and/or input devices).

In some embodiments, while displaying, via the first display generation component, a first area from a first viewpoint, such as in FIG. 6A, the electronic device detects (702a) activation of the second display generation component, such as in response to voice input 622 in FIG. 6A. In some embodiments, the electronic device displays, via the first display generation component, a user interface of a mapping application that includes the first area, such as a geographic area from the first viewpoint. In some embodiments, the geographic area is a type of area displayed by the electronic device via the first display generation component. In some embodiments, the electronic device displays, via the first display generation component, other types of areas other than a geographic area, such as a topographic area or a nautical area. In some embodiments, the user interface displayed via the first display generation component is presented for display on a touch screen of the first display generation component of a vehicle to which the electronic device is connected (e.g., via a wired or wireless connection). For example, a mobile device running the mapping application is connected to a vehicle including the first display generation component and the second display generation component. In some embodiments, the electronic device displays a first portion of the user interface of the mapping application and the first display generation component (e.g., a touch screen) of the vehicle displays a second portion of the user interface of the mapping application simultaneously. In some embodiments, the electronic device displays content or a user interface of an application other than the mapping application while the first display generation component displays the user interface of the mapping application. For example, the electronic device optionally displays a user interface of a music application and the first display generation component is configured to display the user interface of the mapping application. In some embodiments, the first geographic area from the first viewpoint (e.g., overhead view or top-down perspective) includes an area of a map of the first geographic area from a first simulated height (e.g., 50, 100, 200, 400, 600, 800, or 1000 feet) perpendicular to the map centered on a location in the map (optionally corresponding to a location of the electronic device). In some embodiments, the electronic device updates the portion of the geographic region included in the user interface as the electronic device moves, thereby changing the current location of the electronic device, so that the current location of the electronic device remains in the user interface. In some embodiments, the electronic device uses a location sensor (e.g., GPS or other positioning sensor) to identify the current location of the electronic device. In some embodiments, the user provides the current location using a user interface of the mapping application. In some embodiments, the user provides the current location using a system user interface of the electronic device (e.g., voice assistant). In some embodiments, the first geographic area that is centered on the location in the map extends radially from the location by a first amount based on the first viewpoint (e.g., representing 0.5, 1, 1.5, 2, 2.5, 3, 3.5, 4, 4.5, or 5 kilometers). In some embodiments, the location and/or the first geographic area is selected by a user of the electronic device (e.g., by panning or scrolling through the map displayed via the first display generation component via one or more user inputs; or by receiving a sequence of user inputs that corresponds to a request to search for a particular location, geographic area, and/or point of interest). In some embodiments, detecting activation of the second display generation component includes detecting a gesture (e.g., finger tap via touch-sensitive display) at a location of, on, or directed to a second display mode affordance or second display mode user interface object that initiates activation of the second display generation component, different from the first display generation component. In some embodiments, detecting activation of the second display generation component includes detecting, via a hand tracking device, a predefined gesture (e.g., pinch gesture or air tap gesture) directed to activating the second display generation component. In some embodiments, the second display mode affordance is included in a user interface of the first display generation component. In some embodiments, the user interface is a user interface of the mapping application. In some embodiments, the user interface is a user interface of an application other than the mapping application (e.g., a vehicle infotainment system control application) or a system user interface (e.g., of the vehicle infotainment system or of the electronic device). For example, the electronic device is optionally configured to display a vehicle infotainment system control user interface element concurrently with the user interface of the map application. In some embodiments, the vehicle infotainment system control user interface element includes a plurality of user interface objects or affordances corresponding to a plurality of controls for operating one or more systems or functions of the vehicle infotainment system. For example, the one or more systems include a dashboard/instrument cluster system, navigation system, music system, radio system, media system, climate system, and/or multi-display system (e.g., first and second display generation components). In some embodiments, the vehicle infotainment system control user interface element includes the second display mode affordance selectable to control the multi-display system (e.g., turn on/activate or turn off/deactivate the second display generation component). In some embodiments, detecting activation of the second display generation component includes detecting an input via a physical input device of the vehicle that initiates activation of the second display generation component, such as a push button, knob, dial handle or switch. In some embodiments, detecting the input includes detecting a voice input from the user that requests activation of the second display generation component. In some embodiments, the second display generation component is in a sleep state, powered off state, and/or locked state where inputs other than inputs to activate the second display generation component directed to the second display generation component are not detected (e.g., disabling a touch screen) until the electronic device detects the inputs as described herein to activate the second display generation component. In some embodiments, the second display generation component is in a powered on state and/or unlocked state where the second display generation component is currently displaying content. In this case, when the electronic device detects activation of the second display generation component, the electronic device initiates display of or control display of content via the second display generation component as described herein.

In some embodiments, in response to detecting activation of the second display generation component (702b), the electronic device changes (702c) the display of the first geographic area, via the first display generation component, from the first viewpoint, such as first display generation component 504a in FIG. 6A, to be from a second viewpoint, different from the first viewpoint, such as first display generation component 504a in FIG. 6B. For example, the first geographic area from the second viewpoint (e.g., overhead view or top-down perspective) optionally includes the area of the map from a second height (e.g., 300, 400, 600, 800, 1000, 1200, 1300, 1400, or 1500 feet) greater than the first height associated with the first viewpoint and perpendicular to the map centered on the location in the map as described herein. In some embodiments, the second viewpoint includes the first geographic area centered on the location in the map extending radially from the location by a second amount based on the second viewpoint (e.g., representing 3, 3.5, 4, 4.5, 5, 6, 7, 8, 9, 10, 12, 14, 16, 18, 20, or 25 kilometers) greater than the first amount based on the first viewpoint. In some embodiments, the second viewpoint includes a simulated camera angle that is different from the simulated camera angle of the first viewpoint. In some embodiments, the simulated camera angle of the first viewpoint is the same as the simulated camera angle of the second viewpoint. In some embodiments, the first viewpoint includes a first simulated camera angle relative to a normal (perpendicular) to the map. In some embodiments, the electronic device changes the first simulated camera angle (e.g., 5, 10, 15, 20, 30, 35, 40, or 45 degrees from normal) as will be described below.

In some embodiments, the electronic device displays (702d), via the second display generation component, the first geographic area from the first viewpoint, such as second display generation component 504b in FIG. 6B. In some embodiments, in response to detecting activation of the second display generation component, the electronic device activates the second display generation component, including displaying the first geographic area from the first viewpoint concurrently with and/or overlaid upon a user interface of the dashboard/instrument cluster system. In some embodiments, displaying, via the second display generation component, the first geographic area from the first viewpoint includes one or more characteristics of displaying the first geographic area from the first viewpoint via the first display generation component as described herein. In some embodiments, for example when the electronic device displays content or a user interface of an application other than the mapping application (or optionally content from the mapping application), changing the display of the first geographic area, via the first display generation component, from the first viewpoint to be from the second viewpoint and displaying, via the second display generation component, the first geographic area from the first viewpoint does not change the display of the electronic device (e.g., the electronic device continues to display the content or the user interface of the application it was displaying when activation of the second display generation component was detected). In some embodiments, displaying the first geographic area from the respective viewpoints and/or changing the display of the first geographic area from the first viewpoint to be from the second viewpoint is performed without user input to display and/or change the display of the first geographic area via the respective display generation component. In some embodiments, displaying the first geographic area from the second viewpoint using the first display generation component and displaying the first geographic area from the first viewpoint using the second display generation component includes more map information (e.g., more locations, more roads, more points of interest and/or more traffic information) displayed (cumulatively) as compared to displaying the first geographic area from the first viewpoint using the first display generation. In some embodiments, when the electronic device does not detect activation of the second display generation component, the electronic device continues to display, via the first display generation component, the first geographic area from the first viewpoint. For example, the electronic device optionally does not change the display of the first geographic area via the first display generation component from the first viewpoint to be from the second viewpoint until the electronic device detects activation of the second display generation component as described herein. Providing an additional, second viewpoint of a geographic area for display with a first viewpoint of the same geographic when two displays are activated enables a user to easily view and locate map information from two different vantage points, thereby reducing the need for subsequent inputs from a user to zoom in or out of the geographic area which reduces power usage and improves battery life of the electronic device by enabling the user to use the electronic device more quickly and efficiently.

In some embodiments, the first viewpoint includes a simulated overhead view of the first geographic area, such as the first viewpoint of the first display generation component 504a in FIG. 6A. In some embodiments, the simulated overhead view of the first geographic area is based on a virtual camera pointing down at the first geographic area. In some embodiments, the virtual camera is pointing down at a first simulated camera angle from the first simulated height described with reference to method 700. For example, the first simulated camera angle is optionally between 20 to 40 degrees. In some embodiments, the first geographic area is displayed in two dimensions (2D) or three dimensions (3D). For example, the first geographic area includes roads, buildings, points of interest, landmarks, green spaces, and/or infrastructure as described below. In some embodiments, the first geographic area includes a representation of a current location of the electronic device. In some embodiments, when the electronic device is navigating along a route, the electronic device displays the first geographic area including a representation of the route as will be described below. Providing a simulated overhead view of the first geographic area enables a user to easily view and locate map information from a variety of perspectives, thereby reducing the need for subsequent inputs from a user to zoom in or out of the geographic area which reduces power usage and improves battery life of the electronic device by enabling the user to use the electronic device more quickly and efficiently.

In some embodiments, the second viewpoint includes a simulated aerial view of the first geographic area, such as the second viewpoint of the first display generation component 504a in FIG. 6B. In some embodiments, the simulated aerial view of the first geographic area is based on the virtual camera pointing down at the first geographic at a second simulated camera angle greater than the first simulated camera angle associated with the first viewpoint and at the second height described with reference to method 700. For example, the second simulated camera angle is optionally between 40 to 90 degrees. In some embodiments, the second simulated camera angle is less than the first simulated camera angle. In some embodiments, the second simulated camera angle is the same as the first simulated camera angle. Providing a simulated aerial view of the first geographic area enables a user to easily view and locate map information from a variety of perspectives, thereby reducing the need for subsequent inputs from a user to zoom in or out of the geographic area which reduces power usage and improves battery life of the electronic device by enabling the user to use the electronic device more quickly and efficiently.

In some embodiments, displaying, via the first display generation component, the first geographic area from the first viewpoint includes displaying the first geographic area from the first viewpoint in a user interface of a map application, such as map user interface 600 in FIG. 6A. In some embodiments, the electronic device outputs or initiates display of the user interface of the mapping application to the first display generation component of the vehicle. In some embodiments, the electronic device generates the user interface of the mapping application for display on both the electronic device (e.g., mobile device) and the first display generation component of the vehicle.

In some embodiments, the electronic device displays, in the user interface of the map application, a user interface element selectable to change the display of the first geographic area, via the first display generation component, from the first viewpoint to be from the second viewpoint, such as selectable user interface object 624d in FIG. 6D. In some embodiments, the electronic device displays, via the first display generation component, the user interface of the map application including the user interface element. In some embodiments, the electronic device displays, via the second display generation component, the user interface of the map application including the user interface element. In some embodiments, the electronic device detects user input (e.g., a gaze of the user, a contact on a touch-sensitive surface, actuation of a physical input device of the vehicle, a predefined gesture (e.g., pinch gesture or air tap gesture) and/or a voice input from the user) corresponding to selection of the user interface element selectable to change the display of the first geographic area from the first viewpoint to be from the second viewpoint. In response to detecting the user input, the electronic device changes the display of the first geographic area, via the first display generation component, from the first viewpoint to be from the second viewpoint. In some embodiments, while displaying the first geographic area from the second viewpoint, the electronic device detects user input directed to the user interface element. In response to detecting the user input, the electronic device changes the display of the first geographic area, via the first display generation component, from the second viewpoint to be from the first viewpoint. In some embodiments, displaying, via the second display generation component, the first geographic area from the first viewpoint includes displaying the first geographic area from the first viewpoint in a user interface of a map application. In some embodiments, the user interface displayed via the second display generation component includes a user interface element similar to the user interface element selectable to change the display of the first geographic area as described herein. Providing a user interface element selectable to change the display of the first geographic area, via the first display generation component, from the first viewpoint to be from the second viewpoint enables a user to easily switch to view map information from two viewpoints, thereby reducing the need for subsequent inputs from a user to zoom in or out of the geographic area which reduces power usage and improves battery life of the electronic device by enabling the user to use the electronic device more quickly and efficiently.

In some embodiments, while displaying, via the first display generation component, the first geographic area from the first viewpoint, detecting, via the one or input devices, a second input that corresponds to a request to change a zoom level of the first geographic area, such as finger of hand 628 directed to selectable user interface object 624c in FIG. 6E. For example, detecting the second input includes detecting a contact on a touch-sensitive surface to select zoom in and out zoom out buttons, actuation of physical input devices of the vehicle to zoom in and out zoom out, or a pinch gesture to zoom in or out.

In some embodiments, in response to detecting the second input, in accordance with a determination that the request to change the zoom level corresponds to changing the zoom level by a first amount, displaying, via the first display generation component, the first geographic area at a first zoom level including changing the display of the first geographic area from the first viewpoint, such as the first display generation component 504a in FIG. 6E, to be from a third viewpoint, such as the first display generation component 504a in FIG. 6F. In some embodiments, the zoom level by a first amount is based on a magnitude of the second input. For example, the second input is optionally a pinch to zoom gesture including two (finger) contacts directed to the touch-sensitive surface and subsequent movement of the contacts towards each other (e.g., to zoom out of the first geographic area). In another example, the second input is optionally a pinch to zoom gesture including subsequently moving the two (finger) contacts away from each other (e.g., to zoom into the first geographic area). In some embodiments, the first geographic area from the third viewpoint includes an area of the map of the first geographic area from a third simulated height less than the first simulated height associated with the first viewpoint. In some embodiments, the third simulated height is greater than the first simulated height associated with the first viewpoint. In some embodiments, the third viewpoint includes a third simulated camera angle that is different from the simulated camera angle of the first viewpoint. In some embodiments, the third simulated camera angle of the third viewpoint is the same as the simulated camera angle of the first viewpoint. In some embodiments, displaying the first geographic area at the first zoom level including changing the display of the first geographic area from the first viewpoint to be from the third viewpoint includes displaying the area of the map of the first geographic area with more detail than a level of detail of the first viewpoint. For example, the third viewpoint optionally includes trees, foliage, sidewalks, bike lanes, medians, lanes of roads, and/or cross walks that is optionally not included in the first viewpoint. In some embodiments, displaying the first geographic area at the first zoom level including changing the display of the first geographic area from the first viewpoint to be from the third viewpoint includes displaying the area of the map of the first geographic area with less detail than a level of detail of the first viewpoint. For example, the third viewpoint optionally does not include information (e.g., labels) of businesses, landmarks, and/or parks that are optionally included in the first viewpoint.

In some embodiments, in accordance with a determination that the request to change the zoom level corresponds to changing the zoom level by a second amount, different from the first amount, displaying, via the first display generation component, the first geographic area at a second zoom level including changing the display of the first geographic area from the first viewpoint, such as the first display generation component 504a in FIG. 6E, to be from a fourth viewpoint, different from the third viewpoint, such as the first display generation component 504a in FIG. 6G. In some embodiments, the zoom level by the second amount is greater than the zoom level by the first amount. In some embodiments, the zoom level by the second amount is less than the zoom level by the first amount. In some embodiments, the first geographic area from the fourth viewpoint includes an area of the map of the first geographic area from a fourth simulated height less than the third simulated height associated with the third viewpoint. In some embodiments, the fourth simulated height is greater than the third simulated height associated with the third viewpoint. In some embodiments, the fourth viewpoint includes a fourth simulated camera angle that is different from the third simulated camera angle of the third viewpoint. In some embodiments, the fourth simulated camera angle of the fourth viewpoint is the same as the third simulated camera angle of the third viewpoint. In some embodiments, displaying the first geographic area at the second zoom level including changing the display of the first geographic area from the first viewpoint to be from the fourth viewpoint includes displaying the area of the map of the first geographic area with more detail than a level of detail of the third viewpoint. In some embodiments, displaying the first geographic area at the second zoom level including changing the display of the first geographic area from the first viewpoint to be from the fourth viewpoint includes displaying the area of the map of the first geographic area with less detail than a level of detail of the third viewpoint. It is understood that although the embodiments described herein are directed to the first display generation component, such functions and/or characteristics, optionally apply to other display generation components including the second display generation component. In some embodiments, the electronic device maintains display, via the second display generation component, of the first geographic area from the first viewpoint in response to the request to change the zoom level of the first geographic area. For example, the request to change the zoom level of the first geographic area does not include changing the zoom level of the first geographic area via the second display generation component. In some embodiments, the electronic device changes the zoom level of the first geographic area via the second display generation component in response to voice input from the user corresponding to the request to change the zoom level of the first geographic area. Changing the zoom level of the first geographic area via the second display generation component includes one or more characteristics of changing the zoom level via the first display generation component as described herein. Providing the ability to zoom in or out to see greater detail and/or a larger area of the map of the first geographic area in response to user input provides an efficient way of displaying map information, which additionally reduces power usage and improves battery life of the electronic device by enabling the user to use the electronic device more quickly and efficiently.

In some embodiments, displaying, via the first display generation component, the first geographic area from the second viewpoint includes displaying navigation directions along a first route, such as representation 638a in FIG. 6K. For example, navigation directions along the first route from a first location (e.g., location of the first electronic device when navigation directions were requested or specified location inputted by the user via a user interface of a map application) to a second location (e.g., specified destination inputted by the user via a user interface of a map application). In some embodiments, displaying the navigation directions along the first route includes displaying an indication of a current location of the electronic device on the map of the first geographic area, an indication of the first route overlaid on roads, streets, and/or paths on the first geographic area, and/or navigation directions for the first route from the first location to the second location. In some embodiments, while displaying, via the first display generation component, navigation directions along the first route, the electronic device displays, via the second display generation component, navigation directions along the first route from the first viewpoint. In some embodiments, the electronic device displays navigation directions via the second display generation component in a different manner from the display of the navigation instructions via the first display generation component as will be described in more detail below.

In some embodiments, while displaying, via the first display generation component, the navigation directions along the first route, in accordance with a determination that an upcoming route characteristic satisfies one or more first criteria, the electronic device displays, via the first display generation component, a second area from the second viewpoint that is associated with the upcoming route characteristic, such as geographic area displayed via the first display generation component 504a that includes indication 650 of an alternative route in FIG. 6L. In some embodiments, the geographic area is a type of area displayed by the electronic device via the first display generation component. In some embodiments, the electronic device displays, via the first display generation component, other types of areas other than a geographic area, such as a topographic area or a nautical area. In some embodiments, the one or more first criteria include a criterion that is satisfied when the upcoming route characteristic (e.g., traffic congestion, detours, alternative routes, road closings, hazardous conditions, construction, and/or traffic accidents along the first route) is less than a threshold distance from the location of the electronic device (e.g., 0.02, 0.04, 0.06, 0.08, 0.2, 0.4, 0.6, 0.8, 1, 1.5, 2, 3, 4, 5, 6, 7, 8, 9, or 10 kilometers). In some embodiments, the one or more criteria are not satisfied if the upcoming route characteristic is more than the threshold distance from the location of the electronic device or if the route does not have a route characteristic corresponding to a visual alert, such as the route characteristics listed above. In some embodiments, the second geographic area from the second viewpoint as described with reference to method 700 includes a location of the upcoming route characteristic. In some embodiments, the second geographic area from the second viewpoint is different from the first geographic area from the second viewpoint. For example, the second geographic area from the second viewpoint includes the area of the map associated with the location of the upcoming route characteristic from a simulated height greater than the simulated height associated with the first geographic area from the second viewpoint. In some embodiments, the simulated height associated with the second geographic area from the second viewpoint is less than the simulated height associated with the first geographic area from the second viewpoint. In some embodiments, displaying, via the first display generation component, the second geographic area from the second viewpoint that is associated with the upcoming route characteristic includes a simulated camera angle that is different from the simulated camera angle associated with the first geographic area from the second viewpoint. In some embodiments, the simulated camera angle associated with the second geographic area from the second viewpoint is the same as the simulated camera angle associated with the first geographic area from the second viewpoint. In some embodiments, the second geographic area optionally includes a portion of the map associated with the upcoming route characteristic while the first geographic area from the second viewpoint does not include the portion of the map associated with the upcoming route characteristic. In some embodiments, the second geographic area from the second viewpoint includes a larger portion of the map than the portion associated with the first geographic area from the second viewpoint. In some embodiments, the second geographic area from the second viewpoint includes a smaller portion of the map than the portion associated with the first geographic area from the second viewpoint. In some embodiments, the second geographic area from the second viewpoint includes a representation of the upcoming route characteristic at a respective location on the second geographic area. In some embodiments, the representation of the upcoming route characteristic includes a graphical icon such as an image and/or text associated with the upcoming route characteristic. In some embodiments, the representation of the upcoming route characteristic is overlaid on a respective portion of the first route, and/or a second route, different from the first route, as will be described below. In some embodiments, the electronic device displays the second geographic area from the second viewpoint that is associated with the upcoming route characteristic for a predetermined amount of time (e.g., 5, 7, 10, 20, 30, 40, 50, or 60 seconds) before the first electronic device returns to displaying the first geographic area from the second viewpoint as will be described below. In some embodiments, displaying, via the first display generation component, the second geographic area from the second viewpoint that is associated with the upcoming route characteristic does not stop the electronic device from presenting navigation directions along the first route from the first location to the second location.

In some embodiments, while displaying, via the first display generation component, the navigation directions along the first route, in accordance with a determination that an upcoming route characteristic satisfies one or more first criteria, the electronic device maintains display, via the second display generation component, of the first geographic area from the first viewpoint such as the second display generation component 504b in FIG. 6L. In some embodiments, the electronic device displays, via the second display generation component, an indication of the upcoming route characteristic concurrently with the first geographic area from the first viewpoint. In some embodiments, the indication of the upcoming route characteristic includes an image and/or text associated with the upcoming route characteristic as will be described below. In some embodiments, displaying, via the second display generation component, the indication of the upcoming route characteristic does not stop the electronic device from presenting navigation directions along the first route from the first location to the second location. In some embodiments, in accordance with a determination that an upcoming route characteristic does not satisfy the one or more first criteria, the electronic device displays, via the first display generation component, the first geographic area from the second viewpoint including the navigation directions along the first route; and displays, via the second display generation component, the first geographic area from the first viewpoint including the navigation directions along the first route. In some embodiments, the upcoming route characteristic is associated with searching for a location either along the first route or within the first geographic area. For example, the electronic device detects, via the one or input devices, a sequence of user inputs that correspond to a request to add a stop (e.g., destination) along the first route (e.g., after the first location, after the second location, or within the first geographic area). In response to the sequence of inputs, the electronic device determines that an upcoming route characteristic satisfies one or more first criteria (e.g., an area of the map includes one or more search results corresponding to stops along the first route or within the predetermined distance (e.g., 0.02, 0.04, 0.06, 0.08, 0.2, 0.4, 0.6, 0.8, 1, 1.5, 2, 3, 4, 5, 6, 7, 8, 9, or 10 kilometers) from the first geographic area). For example, the electronic device optionally displays, via the first display generation component, a third geographic area from the second viewpoint that is associated with the one or more search results. For example, the third geographic area includes locations of the one or more stops. In some embodiments, while the electronic device displays, via the first display generation component, the third geographic area from the second viewpoint, the electronic device maintains display, via the second display generation component, the first geographic area from the first viewpoint. Displaying, via the first display generation component, the second geographic area from the second viewpoint that is associated with the upcoming route characteristic while maintaining display, via the second display generation component, the first geographic area from the first viewpoint provides map information from two viewpoints including the area related to the upcoming route characteristics, thereby reducing the need for subsequent inputs from a user to pan and/or zoom to the second geographic area related to the upcoming route characteristic which reduces power usage and improves battery life of the electronic device by enabling the user to use the electronic device more quickly and efficiently.

In some embodiments, displaying, via the first display generation component, the second geographic area from the second viewpoint that is associated with the upcoming route characteristic includes displaying a user interface element, such as notification 644a in FIG. 6L. In some embodiments, the user interface element includes information related to the upcoming route characteristic such as a description of the upcoming route characteristic, an amount of potential time saved by taking a route associated with the upcoming route characteristic and/or an updated estimated time of arrival based on the upcoming route characteristic. In some embodiments, the user interface element is displayed concurrently with and/or overlaid on the second geographic area from the second viewpoint. In some embodiments, the user interface element is selectable to initiate an operation associated with the upcoming route characteristic as described herein.

In some embodiments, while displaying, via the first display generation component, the user interface element selectable to initiate an operation associated with the upcoming route characteristic, the electronic device detects, via the one or input devices, a second input that corresponds to selection of the user interface element, such as finger of hand 628 directed to option 644b in FIG. 6L. In some embodiments, the second input includes a gaze of the user, a contact on a touch-sensitive surface, actuation of a physical input device of the vehicle, a predefined gesture (e.g., pinch gesture or air tap gesture), and/or a voice input from the user corresponding to selection of the user interface element. In some embodiments, initiating the operation associated with the upcoming route characteristic includes initiating navigation along a second route, different from the first route as described herein.

In some embodiments, in response to detecting the second input, the electronic device changes the display, via the first display generation component, from the second geographic area from the second viewpoint, such as the first display generation component 504a in FIG. 6L, to be from the first geographic area from the second viewpoint, such as the first display generation component 504a in FIG. 6M, including navigation directions along a second route, different from the first route, such as representation 638a in FIG. 6P. For example, selection of the user interface element optionally results in changing the display, via the first display generation component, back to the first geographic area from the second viewpoint including the simulated height, simulated camera angle, and/or respective portion of the map as described above. In some embodiments, the electronic device returns to displaying, via the first display generation component, the first geographic area from the second viewpoint without further user input to pan and/or zoom to the first geographic area from the second viewpoint. In some embodiments, displaying the first geographic area from the second viewpoint including navigation directions along the second route does not include displaying the representation of the upcoming route characteristic that was previously displayed while displaying the second geographic area from the second viewpoint. In some embodiments, navigation directions along a second route includes navigating along the second route from a third location (e.g., location of the electronic device when the electronic device detects the second input) to the second location associated with the first route or a third location associated with the upcoming route characteristic (e.g., destination presented by the electronic device in response to the user input to search for a particular destination as described above). In some embodiments, displaying the navigation directions along the second route includes displaying an indication of a current location of the electronic device on the first geographic area, an indication of the second route overlaid on roads, streets, and/or paths on the first geographic area, and/or navigation directions for the second route from the third location to the second location associated with the first route or the third location associated with the upcoming route characteristic.

In some embodiments, in response to detecting the second input, the electronic device displays, via the second display generation component, the first geographic area from the first viewpoint including an indication of the second route, such as notification 646 in FIG. 6M. In some embodiments, the indication of the second route includes a graphical image and/or text description indicating navigating along the second route. In some embodiments, the electronic device displays the indication of the second route for a predetermined amount of time (e.g., 5, 7, 10, 20, 30, 40, 50, or 60 seconds) before the first electronic device ceases to display the indication of the second route. In some embodiments, the electronic device displays, via the second display generation component, navigation directions along the second route. In some embodiments, the electronic device displays navigation directions along the second route via the second display generation component that are different from the navigation instructions along the second route displayed via the first display generation component as will be described in more detail below. Changing the display, via the first display generation component, from the second geographic area from the second viewpoint to be from the first geographic area from the second viewpoint including navigation directions along the second route in response to user selection to initiate navigation along the second route provides quick display of the first geographic area from the second viewpoint without requiring the user to provide further inputs to pan and/or zoom to the first geographic area from the second viewpoint, thereby reducing the number of inputs and providing more efficient interactions between the user and the electronic device.

In some embodiments, while displaying, via the first display generation component, the first geographic area from the second viewpoint and displaying, via the second display generation component, the first geographic area from the first viewpoint, the electronic device detects deactivation of a respective display generation component, such as finger of hand 628 directed to selectable user interface object 612c that, when selected, causes the electronic device to display a music player user interface of a music application in FIG. 6I. In some embodiments, detecting deactivation of the respective display generation component includes detecting input such as a gaze of the user, a contact on a touch-sensitive surface, actuation of a physical input device of the vehicle, a predefined gesture (e.g., pinch gesture or air tap gesture), and/or a voice input from the user corresponding to deactivation of a respective display generation component.

In some embodiments, in response to detecting the deactivation of the respective display generation component, and in accordance with a determination that deactivation corresponds to deactivating the first display generation component, the electronic device maintains display, via the second display generation component, of the first geographic area from the first viewpoint, such as second display generation component 504b in FIG. 6I. For example, deactivating the first display generation component includes deactivating control of the first display generation component by the electronic device and/or placing the first display generation component in a sleep state, powered off state, and/or locked state. In some embodiments, the electronic device maintains display, via the second display generation component, of the first geographic area from the first viewpoint until user input to change away from displaying the first geographic area from the first viewpoint as described herein is detected by the electronic device.

In some embodiments, in response to detecting the deactivation of the respective display generation component, and in accordance with a determination that deactivation corresponds to deactivating the first display generation component, the electronic device ceases to display, via the first display generation component, the first geographic area from the second viewpoint, such as the first display generation component 504a in FIG. 6I. For example, the electronic device ceases to display via the first display generation component, the first geographic area from the second viewpoint that was displayed while the first display generation component was in a powered on state, unlocked state, and/or when the first display generation component was configured to display content. In some embodiments, in response to detecting the deactivation of the respective display generation component, and in accordance with a determination that deactivation corresponds to deactivating the second display generation component, such as in response to voice input 652 in FIG. 6N, the electronic device changes the display of the first geographic area, via the first display generation component, from the second viewpoint to be from the first viewpoint, such the first display generation component 504a in FIG. 6O. For example, deactivating the second display generation component includes deactivating control of the second display generation component by the electronic device and/or placing the first display generation component in a sleep state, powered off state, and/or locked state. For example, the electronic device changes the display of the first geographic area, via the first display generation component, from the second viewpoint to be from the first viewpoint without further user input to pan and/or zoom to the first geographic area from the first viewpoint.

In some embodiments, in response to detecting the deactivation of the respective display generation component, and in accordance with a determination that deactivation corresponds to deactivating the second display generation component, the electronic device ceases to display, via the second display generation component, the first geographic area from the first viewpoint, such the second display generation component 504b in FIG. 6O. For example, the electronic device ceases to display via the second display generation component, the first geographic area from the first viewpoint that was displayed while the second display generation component was in a powered on state, unlocked state, and/or when the second display generation component was configured to display content. Displaying the first geographic area from the first viewpoint in response to one display generation component being activated provides quick display of map information from the first viewpoint without requiring the user to provide further inputs to pan and/or zoom to the first geographic area from the first viewpoint, thereby reducing the number of inputs and providing more efficient interactions between the user and the electronic device.

In some embodiments, displaying, via the first display generation component, the first geographic area from the second viewpoint includes displaying first content, such as representations 624b, 624h, 624f, and 605 in FIG. 6B. In some embodiments, the electronic device displays, via the first display generation component, the first geographic area from the second viewpoint including the first content while navigation along a route is not occurring (e.g., while exploring the first geographic area, performing a search, or viewing recent destinations or favorites/bookmarks). For example, content displayed while navigating along a route will be discussed below. In some embodiments, the first content includes representation of map data such as streets, highways, weather information, traffic information, nearby one or more first points of interest, and/or nearby wireless network coverage.

In some embodiments, displaying, via the second display generation component, the first geographic area from the first viewpoint includes displaying second content (different from the first content), such as indications 620b, 620c, and 620d in FIG. 6B. In some embodiments, the second content is the same as the first content. For example, while exploring the first geographic area, the first content and second content optionally both include a respective representation of the first geographic area, an indication of a current location of the electronic device on the first geographic area, and/or an estimated (e.g., variable) speed at which the user of the electronic device will be able to drive along a respective route. In some embodiments, the second content is different from the second content. In contrast, the second content optionally includes representations of map data such as streets, highways, and/or nearby one or more first points of interest. Displaying respective content on a respective display generation component provides a more tailored user interface that is less cluttered and includes more of the desired content for display on the respective display generation component, which additionally reduces power usage and improves battery life of the electronic device by enabling the user to use the electronic device more quickly and efficiently.

In some embodiments, while displaying, via the first display generation component, the first geographic area from the second viewpoint including the first content and displaying, via the second display generation component, the first geographic area from the first viewpoint including the second content, the electronic device detects, via the one or input devices, a second input corresponding to a request to cease display of the first geographic area via the first display generation component, such as finger of hand 628 directed to selectable user interface object 612c in FIG. 6H. In some embodiments, the second input is a gaze of the user, a contact on a touch-sensitive surface, actuation of a physical input device of the vehicle, a predefined gesture (e.g., pinch gesture or air tap gesture), and/or a voice input from the user corresponding to ceasing to display the first geographic area via the first display generation component. In some embodiments, ceasing to display the first geographic area via the first display generation component does not include deactivation of the first display generation component. For example, the electronic device continues to display user interfaces and/or content other than the first geographic area such as user interfaces and/or content associated with another application, such as a music, radio, and/or media application. In some embodiments, when the first content includes representation of map data such as streets, highways, weather information, traffic information, nearby one or more first points of interest, and/or nearby wireless network coverage, the second content includes a subset of map data included in the first content. For example, the second content optionally includes representations of map data such as streets, highways, and/or nearby one or more first points of interest. In some embodiments, the second content optionally includes the map data included in the first content including more or less representations of map data.

In some embodiments, in response to detecting the second input, the electronic device changes the display of the first geographic area, via the second display generation component, from the first viewpoint including the second content to include third content, such as In some embodiments, compass user interface element 642 displayed via the second display generation component 504b. In some embodiments, the third content is different from the second content. For example, the second content optionally includes representations of map data such as streets, highways, and/or nearby one or more first points of interest while the third content optionally includes the map data included in the second content including more or less representations of map data. For example, the third content optionally includes representations of map data such as streets, highways, nearby one or more first points of interest and/or an estimated (e.g., variable) speed at which the user of the electronic device will be able to drive along a respective route. In some embodiments, the third content was not previously displayed before detecting the second input.

In some embodiments, in response to detecting the second input, the electronic device ceases to display, via the first display generation component, the first geographic area from the second viewpoint including the first content as shown in FIG. 6I, such as the first display generation component 504a in FIG. 6I. Changing content presented in response to one display generation component displaying the first geographic area provides quick display of map information without requiring the user to provide further inputs to locate content previously displayed by two display generation components, thereby reducing the number of inputs and providing more efficient interactions between the user and the electronic device.

In some embodiments, while displaying, via the second display generation component, the first geographic area from the first viewpoint including the third content, the electronic device detects, via the one or input devices, a third input corresponding to a request to display the first geographic area via the first display generation component, such as in response to voice input 632 in FIG. 6I. In some embodiments, the third input includes a gaze of the user, a contact on a touch-sensitive surface, actuation of a physical input device of the vehicle, a predefined gesture (e.g., pinch gesture or air tap gesture), and/or a voice input from the user corresponding to display the first geographic area via the first display generation component. In some embodiments, the electronic device receives the third input while the first display generation component is idle, sleeping, deactivated, or otherwise not displaying a user interface. In some embodiments, the electronic device receives the third input while the first display generation component is displaying a user interface of an application other than the application for displaying maps. In some embodiments, displaying the first geographic area via the first display generation component causes other user interfaces and/or content displayed via the first display generation component to change in visual appearance as will be described below. In some embodiments, and as will be described herein, the electronic device displays representations of map data, via the first display generation component that was previously displayed via the second display generation component.

In some embodiments, in response to detecting the third input, the electronic device changes the display of the first geographic area, via the second display generation component, from the first viewpoint including the third content to include fourth content, such as representations 620a, 620b, 620c, and 620d in FIG. 6B. In some embodiments, the fourth content is different from the third content. In some embodiments, the fourth content includes less representations of map data than the third content. For example, when the third content includes representations of map data such as streets, highways, nearby one or more first points of interest and/or an estimated (e.g., variable) speed at which the user of the electronic device will be able to drive along a respective route, the fourth content includes representations of map data such as streets, highways and/or an estimated (e.g., variable) speed at which the user of the electronic device will be able to drive along a respective route. In some embodiments, the fourth content was not previously displayed before detecting the third input.

In some embodiments, in response to detecting the third input, the electronic device displays, via the first display generation component, the first geographic area from the second viewpoint including fifth content different from the fourth content, such as representations 624b, 624h, 624f, and 604 in FIG. 6B. In some embodiments, the fifth content includes the third content. For example, the third content (e.g., displayed via the second display generation component while the electronic device was not displaying the first geographic area via the first display generation component) is optionally no longer displayed via the second display generation component and is being displayed via the first display generation component. In some embodiments, the electronic device displays representations of map data previously displayed via the second display generation component to be displayed via the first display generation component. In some embodiments, the fifth content was not previously displayed before detecting the third input. Changing content presented in response to two display generation components displaying the first geographic area provides quick display of map information without requiring the user to provide further inputs to locate content and distribute content to be displayed by two display generation components, thereby reducing the number of inputs and providing more efficient interactions between the user and the electronic device.

In some embodiments, while displaying, via the first display generation component, the first geographic area from the second viewpoint including the first content and displaying, via the second display generation component, the first geographic area from the first viewpoint including the second content, the electronic device detects, via the one or input devices, a second input corresponding to a request to cease display of the first geographic area via the second display generation component, such as in response to voice input 652 in FIG. 6N. In some embodiments, the second input includes a gaze of the user, a contact on a touch-sensitive surface, actuation of a physical input device of the vehicle, a predefined gesture (e.g., pinch gesture or air tap gesture), and/or a voice input from the user corresponding to ceasing to display the first geographic area via the second display generation component. In some embodiments, the electronic device receives the second input while the second display generation component is active and/or displaying a user interface. In some embodiments, the electronic device receives the second input while the second display generation component is displaying a user interface of an application other than the application for displaying maps. In some embodiments, ceasing to display the first geographic area via the second display generation component includes deactivation of the second display generation component. In some embodiments, ceasing to display the first geographic area via the second display generation component does not include deactivation of the second display generation component. For example, the electronic device continues to display user interfaces and/or content other than the first geographic area such as user interfaces and/or content associated with an application other than the application for displaying maps, such as an application associated with music, radio, and/or media.

In some embodiments, in response to detecting the second input, the electronic device changes the display of the first geographic area, via the first display generation component, from the second viewpoint including the first content to the first viewpoint including third content, such as indication 602 in FIG. 6O. In some embodiments, the third content is different from the first content. For example, while the electronic device performs a map exploration of the first geographic area, such as panning, scrolling, navigating and/or zooming in/out of the first geographic area. In some embodiments, the first content (e.g., displayed while the electronic device displayed the first geographic area via the second display generation component) includes a respective representation (e.g., a map) of the first geographic area, an indication of a current location of the electronic device on the first geographic area, and/or first representations of corresponding points of interest from the second viewpoint. The third content optionally includes a respective representation of the first geographic area, an indication of a current location of the electronic device on the first geographic area, and/or second representations of corresponding points of interest from the first viewpoint. In some embodiments, the number of first representations of corresponding points of interest included in the first content is greater than the number of second representations of corresponding points of interest included in the third content. For example, the first geographic area from the second viewpoint including the first content includes a larger portion of the map than the portion associated with the first geographic area from the first viewpoint including the third content. In some embodiments, the third content was not previously displayed before detecting the second input.

In some embodiments, in response to detecting the second input, the electronic device ceases to display, via the second display generation component, the first geographic area from the first viewpoint including the second content, such as second display generation component 504b in FIG. 6O. In some embodiments, the second content is the same content as the third content. In some embodiments, the second content is different from the third content. For example, the second content optionally includes a number of representations of corresponding points of interest less than the number of second representations of corresponding points of interest associated with the first geographic area from the first viewpoint of the first display generation component. In some embodiments, the electronic device displays representations of map data previously displayed via two display generation components (e.g., the first display generation component and the second display generation component) to be displayed via the first display generation component. In some embodiments, the electronic device displays a subset (e.g., more or less) of the representations of map data to be displayed via the first display generation component as described herein. Changing content presented in response to one display generation component displaying the first geographic area provides quick display of map information without requiring the user to provide further inputs to locate content previously displayed by two display generation components, thereby reducing the number of inputs and providing more efficient interactions between the user and the electronic device.

In some embodiments, while displaying, via the first display generation component, the first geographic area from the first viewpoint including the third content, the electronic device detects, via the one or input devices, a third input corresponding to a request to display the first geographic area via the second display generation component, such as in response to voice input 654 in FIG. 6O. In some embodiments, the third input includes a gaze of the user, a contact on a touch-sensitive surface, actuation of a physical input device of the vehicle, a predefined gesture (e.g., pinch gesture or air tap gesture), and/or a voice input from the user corresponding to display the first geographic area via the second display generation component. In some embodiments, displaying the first geographic area via the second display generation component causes other user interfaces and/or content displayed via the second display generation component to change in visual appearance as will be described below.

In some embodiments, in response to detecting the third input, the electronic device changes the display of the first geographic area, via the first display generation component, from the first viewpoint including the third content to the second viewpoint including fourth content, such as representations 624h, 650, 604, and 642 in FIG. 6P. In some embodiments, the fourth content is different from the third content. For example, the third content as described above optionally includes the respective representation of the first geographic area, the indication of a current location of the electronic device on the first geographic area, and/or second representations of corresponding points of interest from the first viewpoint and the fourth content optionally includes the respective representation of the first geographic area, the indication of a current location of the electronic device on the first geographic area, and/or third representations of corresponding points of interest from the second viewpoint. In some embodiments, the number of third representations of corresponding points of interest is greater than the number of second representations of corresponding points of interest. For example, the first geographic area from the second viewpoint including the fourth content includes a larger portion of the map than the portion associated with the first geographic area from the first viewpoint including the third content. In some embodiments, the fourth content was not previously displayed before detecting the third input.

In some embodiments, in response to detecting the third input, the electronic device displays, via the second display generation component, the first geographic area from the first viewpoint including fifth content different from the fourth content, such as representations 620a, 620b, and 640c in FIG. 6P. In some embodiments, the third content (e.g., displayed via the first display generation component while the electronic device ceased displaying the first geographic area via the second display generation component) is no longer displayed via the first display generation component and is being displayed via the second display generation component. For example, the fourth content is optionally the same as the third content (e.g., the fourth content includes the respective representation of the first geographic area, the indication of a current location of the electronic device on the first geographic area, and/or second representations of corresponding points of interest from the first viewpoint). In some embodiments, the fifth content was not previously displayed before detecting the third input. Changing content presented in response to two display generation components displaying the first geographic area provides quick display of map information without requiring the user to provide further inputs to locate content and distribute content to be displayed by two display generation components, thereby reducing the number of inputs and providing more efficient interactions between the user and the electronic device.

In some embodiments, while displaying, via the first display generation component, the first geographic area from the second viewpoint including the first content and displaying, via the second display generation component, the first geographic area from the first viewpoint including the second content, the electronic device detects, via the one or input devices, a second input corresponding to a request to display a user interface element, such as finger of hand 628 directed to selectable user interface object 612c in FIG. 6M. In some embodiments, the second input includes a gaze of the user, a contact on a touch-sensitive surface, actuation of a physical input device of the vehicle, a predefined gesture (e.g., pinch gesture or air tap gesture), and/or a voice input from the user corresponding to a request to display a user interface element. In some embodiments, the user interface element is a user interface element of an application other than the map application, such as a music application, a radio application, a media application (e.g., news and/or entertainment), a calendar application, a food and/or service ordering application, a calling and/or messaging application, a weather application, and/or a utility application (e.g., locating parking, charging stations, or gas stations). In some embodiments, the user interface element of the application other than the map application includes information related to the associated application (e.g., music, radio, media, calendar, food and/or services, messages, weather, and/or utility content and/or selectable user interface elements). In some embodiments, the electronic device changes the display of the user interface element of the application other than the map application, such as resizing and/or adding or removing information and/or selectable user interface elements related to the associated application. In some embodiments, the user interface element of the application other than the map application includes selectable user interface elements to perform actions associated with the corresponding application such as for example, playing music, displaying content, initiating an order, initiating a call, and/or drafting a message.

In some embodiments, in response to detecting the second input, the electronic device displays, via the first display generation component, the user interface element and third content, different from the first content or displays, via the second display generation component, fourth content, different from the second content, such as shown in user interfaces 634 and 600 in FIG. 6N. In some embodiments, the electronic device displays, via the first display generation component, the user interface element in a first portion of the display generation component and the respective content (e.g., third content or fourth content) in a second portion of the display generation component that is different from the first portion. In some embodiments, the first portion is a size smaller or larger than the second portion. In some embodiments, the first portion is a same size as the second portion. In some embodiments, the third content is less than the first content. In some embodiments, the third content is more than the first content. In some embodiments, the fourth content is less than the second content. In some embodiments, the fourth content is more than the second content. In some embodiments, the third content was not previously displayed before detecting the second input. In some embodiments, the fourth content was not previously displayed before detecting the third input. Displaying respective content including a user interface element on a respective display generation component provides a more tailored user interface that is less cluttered, which additionally reduces power usage and improves battery life of the electronic device by enabling the user to use the electronic device more quickly and efficiently.

In some embodiments, while displaying, via the first display generation component, the first geographic area from the second viewpoint including the first content and displaying, via the second display generation component, the first geographic area from the first viewpoint including the second content, the electronic device detects, via the one or input devices, a second input corresponding to a request to display a user interface element, such as finger of hand 628 directed to selectable user interface object 612c in FIG. 6M. For example, the request to display a user interface element includes a request to display a user interface element of an application other than the mapping application. For example, the user interface element is selectable to optionally cause playback of media content (e.g., music, podcast, video, or audiobook), initiate a call, initiate an order, or view messaging content. In some embodiments, the second input is a gaze of the user, a contact on a touch-sensitive surface, actuation of a physical input device of the vehicle, a predefined gesture (e.g., pinch gesture or air tap gesture), and/or a voice input from the user corresponding to a request to display a user interface element. In some embodiments, the user interface element of the application other than the map application includes information related to the associated application as described above. In some embodiments, the electronic device changes the display of the user interface element of the application other than the map application, such as resizing and/or adding or removing information and/or selectable user interface elements related to the associated application. In some embodiments, the user interface element of the application other than the map application includes selectable user interface elements to perform actions associated with the corresponding application as described above.

In some embodiments, in response to detecting the second input, the electronic device changes the display of the first geographic area, via the first display generation component, from the second viewpoint, such as the first display generation component 504a in FIG. 6M, to be from a third viewpoint different from the second viewpoint such as the first display generation component 504a in FIG. 6N. In some embodiments, the first geographic area from the third viewpoint includes an area of the map of the first geographic area from a third simulated height less than the simulated height associated with the second viewpoint. In some embodiments, the third simulated height is greater than the simulated height associated with the second viewpoint. In some embodiments, the third viewpoint includes a third simulated camera angle that is different from the simulated camera angle of the second viewpoint. In some embodiments, the third simulated camera angle of the third viewpoint is the same as the simulated camera angle of the second viewpoint.

In some embodiments, in response to detecting the second input, the electronic device changes the display of the first geographic area, via the second display generation component, from the first viewpoint, such as the second display generation component 504b in FIG. 6F, to be from a fourth viewpoint, different from the first viewpoint, such as the second display generation component 504b in FIG. 6M. In some embodiments, the first geographic area from the fourth viewpoint includes an area of the map of the first geographic area from a fourth simulated height less than the simulated height associated with the first viewpoint. In some embodiments, the fourth simulated height is greater than the simulated height associated with the first viewpoint. In some embodiments, the fourth viewpoint includes a fourth simulated camera angle that is different from the simulated camera angle of the first viewpoint. In some embodiments, the fourth simulated camera angle of the third viewpoint is the same as the simulated camera angle of the first viewpoint.

In some embodiments, in response to detecting the second input, the electronic device displays, via the first display generation component, the user interface element, such as user interface 634 in FIG. 6N. In some embodiments, the electronic device displays, via the respective display generation component, the user interface element in a first portion of the display generation component and the first geographic area from a respective viewpoint in a second portion of the display generation component that is different from the first portion. In some embodiments, the first portion is a size smaller or larger than the second portion. In some embodiments, the first portion is a same size as the second portion. In some embodiments, user requests to zoom in or out of the respective geographic area via the respective display generation component is performed similarly to the requests to zoom in or out of the geographic area as described above. Providing different viewpoints of a geographic area for display including a user interface element on respective display generation components enables a user to easily view and locate map information from different vantage points and interact with the user interface element, thereby reducing the need for subsequent inputs from a user to zoom in or out of the geographic area which reduces power usage and improves battery life of the electronic device by enabling the user to use the electronic device more quickly and efficiently.

In some embodiments, while navigating along a first route and while displaying, via the first display generation component, the first geographic area from the first viewpoint and displaying, via the second display generation component, the first geographic area from the second viewpoint, in accordance with a determination that an upcoming maneuver of the first route satisfies one or more first criteria, the electronic device displays using the first display generation component, a first indication of the upcoming maneuver, such as representation 638a in FIG. 6K. In some embodiments, the one or more first criteria include a criterion that is satisfied when the location of the maneuver is less than a threshold distance from the location of the electronic device (e.g., 0.02, 0.04, 0.06, 0.08, 0.2, 0.4, 0.6, 0.8, 1, 1.5, 2, 3, 4, 5, 6, 7, 8, 9, or 10 kilometers). In some embodiments, the one or more first criteria include a criterion that is satisfied when the type of the upcoming maneuver matches a predetermined maneuver type, such as turning, exiting, merging, etc. In some embodiments, the one or more first criteria are not satisfied if the maneuver is more than the threshold distance from the location of the electronic device or if the maneuver is a type not included in the predetermined maneuver types, such as continuing straight.

In some embodiments, the first indication of the upcoming maneuver includes a description of and/or icon illustrating the maneuver type, a location of the upcoming maneuver, and/or a distance between the location of the electronic device and the location of the maneuver. In some embodiments, the first indication of the upcoming maneuver is displayed as a banner user interface element overlaid over the first geographic area or along one or more edges of a user interface of the first display generation component.

In some embodiments, while navigating along a first route and while displaying, via the first display generation component, the first geographic area from the first viewpoint and displaying, via the second display generation component, the first geographic area from the second viewpoint, in accordance with a determination that an upcoming maneuver of the first route satisfies one or more first criteria, the electronic device displays, via the second display generation component, a second indication of the upcoming maneuver, different from the first indication of the upcoming maneuver, such as representation 640a in FIG. 6K. In some embodiments, the second indication of the upcoming maneuver includes a description and/or icon of the maneuver type. In some embodiments, the second indication is displayed via the second display generation component for less time than the first indication is displayed via the first display generation component. Displaying different indications of the upcoming maneuver on a respective display generation component provides a more tailored user interface that is less cluttered and includes more of the desired content for display on the respective display generation component, which additionally reduces power usage and improves battery life of the electronic device by enabling the user to use the electronic device more quickly and efficiently.

In some embodiments, while displaying, via the first display generation component, the first geographic area from the second viewpoint including the first indication of the upcoming maneuver and displaying, via the second display generation component, the first geographic area from the first viewpoint including the second indication of the upcoming maneuver, the electronic device detects, via the one or input devices, a second input corresponding to a request to cease display of the first geographic area via the first display generation component, such as finger of hand 628 directed to selectable user interface object 612c in FIG. 6H. In some embodiments, the second input includes a gaze of the user, a contact on a touch-sensitive surface, actuation of a physical input device of the vehicle, a predefined gesture (e.g., pinch gesture or air tap gesture), and/or a voice input from the user corresponding to ceasing to display the first geographic area via the first display generation component. In some embodiments, ceasing to display the first geographic area via the first display generation component does not include ceasing navigation along the first route. For example, the electronic device continues to display user navigation instructions including one or more upcoming maneuvers via the second display generation component as described below and/or providing audio indications of upcoming navigation maneuvers. In some embodiments, ceasing to display the first geographic area via the first display generation component does not include deactivation of the first display generation component. For example, the electronic device continues to display user interfaces and/or content other than the first geographic area such as user interfaces of other applications, such as applications associated with music, radio, and/or media.

In some embodiments, in response to detecting the second input, the electronic device changes the display of the first geographic area, via the second display generation component, from the first viewpoint including the second indication of the upcoming maneuver to include a third indication of the upcoming maneuver, such as for example, In some embodiments, the second display generation component 504b including representation 638e of FIG. 6K. In some embodiments, the third indication of the upcoming maneuver is different from the second indication of the upcoming maneuver. In some embodiments, the third indication of the upcoming maneuver is the same as the second indication of the upcoming maneuver. In some embodiments, the third indication of the upcoming maneuver includes more information than the second indication of the upcoming maneuver. For example, when the second indication of the upcoming maneuver optionally includes a description and/or icon of the maneuver type as described herein, the third indication of the upcoming maneuver includes a description and/or icon of the maneuver type, and/or a location of the upcoming maneuver.

In some embodiments, in response to detecting the second input, the electronic device ceases to display, via the first display generation component, the first geographic area from the second viewpoint including the first indication of the upcoming maneuver, such as first display generation component 504a in FIG. 6I. In some embodiments, the first indication of the upcoming maneuver includes the same user interface elements as the third indication of the upcoming maneuver. In some embodiments, the first indication of the upcoming maneuver is different from the third indication of the upcoming maneuver. For example, the first indication of the upcoming maneuver optionally includes a description of and/or icon illustrating the maneuver type, a location of the upcoming maneuver, and/or a distance between the location of the electronic device and the location of the maneuver. Changing content presented in response to one display generation component displaying information related to an upcoming navigation maneuver provides quick display of map information without requiring the user to provide further inputs to locate content previously displayed by two display generation components, thereby reducing the number of inputs and providing more efficient interactions between the user and the electronic device.

In some embodiments, while displaying, via the second display generation component, the first geographic area from the first viewpoint including the third indication of the upcoming maneuver, the electronic device detects, via the one or input devices, a third input corresponding to a request to display the first geographic area via the first display generation component, such as in response to voice input 632 in FIG. 6I. In some embodiments, the third input includes a gaze of the user, a contact on a touch-sensitive surface, actuation of a physical input device of the vehicle, a predefined gesture (e.g., pinch gesture or air tap gesture), and/or a voice input from the user corresponding to display the first geographic area via the first display generation component. In some embodiments, the electronic device receives the third input while the first display generation component is displaying a user interface of an application other than the mapping application or a system user interface of the electronic device or while the first display generation component is inactive.

In some embodiments, in response to detecting the third input, the electronic device changes the display of the first geographic area, via the second display generation component, from the first viewpoint including the third indication of the upcoming maneuver to include a fourth indication of the upcoming maneuver, such as representation 640a in FIG. 6K. In some embodiments, the fourth indication of the upcoming maneuver is different from the third indication of the upcoming maneuver. For example, the third indication of the upcoming maneuver as described above optionally includes a description of and/or icon illustrating the maneuver type, and/or an indication of a location of the upcoming maneuver and the fourth content optionally includes a description of and/or icon illustrating the maneuver type without an indication of the location of the upcoming maneuver.

In some embodiments, in response to detecting the third input, the electronic device displays, via the first display generation component, the first geographic area from the second viewpoint including a fifth indication of the upcoming maneuver, such as representation 638a in FIG. 6K. In some embodiments, one or more elements of the third indication of the upcoming maneuver (e.g., displayed via the second display generation component while the electronic device was not displaying the first geographic area via the first display generation component) is no longer displayed via the second display generation component and is being displayed via the first display generation component. For example, the fourth indication of the upcoming maneuver is optionally the same as the third indication of the upcoming maneuver (e.g., the fourth indication of the upcoming maneuver includes the description and/or icon of the maneuver type, and/or a location of the upcoming maneuver). Changing an indication of an upcoming maneuver presented in response to two display generation components displaying the first geographic area provides quick display of map information without requiring the user to provide further inputs to locate content associated with the upcoming maneuver and distribute the content to be displayed by two display generation components, thereby reducing the number of inputs and providing more efficient interactions between the user and the electronic device.

In some embodiments, while displaying, via the first display generation component, the first geographic area from the second viewpoint including the first indication of the upcoming maneuver and displaying, via the second display generation component, the first geographic area from the first viewpoint including the second indication of the upcoming maneuver, the electronic device detects, via the one or input devices, a second input corresponding to a request to cease display of the first geographic area via the second display generation component, such as in response to voice input 652 in FIG. 6N. In some embodiments, the second input includes a gaze of the user, a contact on a touch-sensitive surface, actuation of a physical input device of the vehicle, a predefined gesture (e.g., pinch gesture or air tap gesture), and/or a voice input from the user corresponding to ceasing to display the first geographic area via the second display generation component. In some embodiments, ceasing to display the first geographic area via the second display generation component does not include ceasing navigation along the first route. For example, the electronic device continues to display user navigation instructions including one or more upcoming maneuvers via the first display generation component as described below and/or providing audio indications of upcoming navigation maneuvers. In some embodiments, ceasing to display the first geographic area via the second display generation component does not include deactivation of the second display generation component. For example, the electronic device continues to display user interfaces and/or content other than the first geographic area such as user interfaces of other applications, such as applications associated with music, radio, and/or media.

In some embodiments, in response to detecting the second input, the electronic device changes the display of the first geographic area, via the first display generation component, from the second viewpoint including the first indication of the upcoming maneuver, such as the first display generation component 504a in FIG. 6P, to the first viewpoint including a third indication of the upcoming maneuver, such as the first display generation component 504a in FIG. 6O. In some embodiments, the third indication of the upcoming maneuver is different from the first indication of the upcoming maneuver. In some embodiments, the third indication of the upcoming maneuver is the same as the first indication of the upcoming maneuver. In some embodiments, the third indication of the upcoming maneuver includes more information than the first indication of the upcoming maneuver. For example, when the first indication of the upcoming maneuver optionally includes a description of and/or icon illustrating the maneuver type as described herein, the third indication of the upcoming maneuver includes a description of and/or icon illustrating the maneuver type, a location of the upcoming maneuver and/or a distance between the location of the electronic device and the maneuver type.

In some embodiments, in response to detecting the second input, the electronic device ceases to display, via the second display generation component, the first geographic area from the first viewpoint including the second indication of the upcoming maneuver, such as the second display generation component 504b in FIG. 6O. As described above, in some embodiments, ceasing to display the first geographic area from the first viewpoint via the second display generation component does not include deactivating the first display generation component. In some embodiments, the electronic device displays a user interface of an application other than a maps application in response to detecting the second input. In some embodiments, the electronic device deactivates the second display generation component in response to detecting the second input. Changing content presented in response to one display generation component displaying information related to an upcoming navigation maneuver provides quick display of map information without requiring the user to provide further inputs to locate content previously displayed by two display generation components, thereby reducing the number of inputs and providing more efficient interactions between the user and the electronic device.

In some embodiments, while displaying, via the first display generation component, the first geographic area from the first viewpoint including the third indication of the upcoming maneuver, the electronic device detects, via the one or input devices, a third input corresponding to a request to display the first geographic area via the second display generation component, such as in response to voice input 654 in FIG. 6O. In some embodiments, the third input includes a gaze of the user, a contact on a touch-sensitive surface, actuation of a physical input device of the vehicle, a predefined gesture (e.g., pinch gesture or air tap gesture), and/or a voice input from the user corresponding to display the first geographic area via the second display generation component.

In some embodiments, in response to detecting the third input, the electronic device changes the display of the first geographic area, via the first display generation component, from the first viewpoint including the third indication of the upcoming maneuver, such as the first display generation component 504a in FIG. 6O, to the second viewpoint including a fourth indication of the upcoming maneuver, such as the first display generation component 504a in FIG. 6P. In some embodiments, the fourth indication of the upcoming maneuver is different from the third indication of the upcoming maneuver. For example, the third indication of the upcoming maneuver as described above optionally includes a description of and/or icon illustrating the maneuver type, and/or a location of the upcoming maneuver and the fourth indication of the upcoming maneuver optionally includes a description of and/or icon illustrating the maneuver type, a location of the upcoming maneuver and/or a distance between the location of the electronic device and the location of the maneuver.

In some embodiments, in response to detecting the third input, the electronic device displays, via the second display generation component, the first geographic area from the first viewpoint including a fifth indication of the upcoming maneuver, such as the second display generation component 504b in FIG. 6P. In some embodiments, one or more elements of the third indication of the upcoming maneuver (e.g., displayed via the second display generation component while the electronic device was not displaying the first geographic area via the first display generation component) is no longer displayed via the second display generation component and is being displayed via the first display generation component. For example, the fifth indication of the upcoming maneuver is optionally the same as the first indication of the upcoming maneuver (e.g., the fifth indication of the upcoming maneuver includes the description and/or icon of the maneuver type). Changing an indication of an upcoming maneuver presented in response to two display generation components displaying the first geographic area provides quick display of map information without requiring the user to provide further inputs to locate content associated with the upcoming maneuver and distribute the content to be displayed by two display generation components, thereby reducing the number of inputs and providing more efficient interactions between the user and the electronic device.

In some embodiments, while displaying, via the first display generation component, the first geographic area from the second viewpoint including the first indication of the upcoming maneuver and displaying, via the second display generation component, the first geographic area from the first viewpoint including the second indication of the upcoming maneuver, the electronic device detects, via the one or input devices, a second input corresponding to a request to display a user interface element, such as finger of hand 628 directed to selectable user interface object 612c in FIG. 6M. In some embodiments, the second input is a gaze of the user, a contact on a touch-sensitive surface, actuation of a physical input device of the vehicle, a predefined gesture (e.g., pinch gesture or air tap gesture), and/or a voice input from the user corresponding to a request to display a user interface element. In some embodiments, the user interface element is a user interface element of an application other than the map application as described herein. In some embodiments, the electronic device detects the second input while the first display generation component is not displaying a user interface of an application that is not associated with the mapping application. For example, the request to display a user interface element includes a request to display a user interface element of an application other than the mapping application. For example, the user interface element is selectable to optionally cause playback of media content (e.g., music, podcast, video, or audiobook), initiate a call, initiate an order, or view messaging content. In some embodiments, the user interface element of the application other than the map application includes information related to the associated application as described above. In some embodiments, the electronic device changes the display of the user interface element of the application other than the map application, such as resizing and/or adding or removing information and/or selectable user interface elements related to the associated application. In some embodiments, the user interface element of the application other than the map application includes selectable user interface elements to perform actions associated with the corresponding application as described above.

In some embodiments, in response to detecting the second input, the electronic device displays, via the first display generation component, the user interface element and displays, via the first display generation component, a third indication of the upcoming maneuver, different from the first indication of the upcoming maneuver, such as for example, and in some embodiments, the first display generation component 504a including representation 638a in FIG. 6O, or displays, via the second display generation component, a fourth indication of the upcoming maneuver, different from the second indication of the upcoming maneuver, such for example, and in some embodiments, the second display generation component 504b including representation 638a in FIG. 6K. In some embodiments, the electronic device displays, via the first display generation component, the user interface element in a first portion of the first display generation component and the third indication of the upcoming maneuver in a second portion of the first display generation component that is different from the first portion. In some embodiments, the electronic device displays, via the second display generation component, the user interface element in the first portion of the second display generation component and the fourth indication of the upcoming maneuver in a second portion of the second display generation component that is different from the first portion. In some embodiments, the first portion is a different size (e.g., smaller or larger) than the size of the second portion. In some embodiments, the first portion is a same size as the second portion. In some embodiments, the third indication of the upcoming maneuver includes less information, content, and/or user interface elements than the first indication of the upcoming maneuver as described herein. In some embodiments, the third indication of the upcoming maneuver includes more information, content, and/or user interface elements than the first indication of the upcoming maneuver. In some embodiments, the fourth indication of the upcoming maneuver includes less information, content, and/or user interface elements than the second indication of the upcoming maneuver as described herein. In some embodiments, the fourth indication of the upcoming maneuver includes more information, content, and/or user interface elements than the second indication of the upcoming maneuver. In some embodiments, the third indication was not previously displayed before detecting the second input. In some embodiments, the fourth indication was not previously displayed before detecting the third input. Displaying a respective indication of an upcoming navigation maneuver including a user interface element on a respective display generation component provides a more tailored user interface that is less cluttered, which additionally reduces power usage and improves battery life of the electronic device by enabling the user to use the electronic device more quickly and efficiently.

In some embodiments, while displaying, via the first display generation component, the first geographic area from the second viewpoint including the first indication of the upcoming maneuver and displaying, via the second display generation component, the first geographic area from the first viewpoint including the second indication of the upcoming maneuver, the electronic device detects, via the one or input devices, a second input corresponding to a request to display a user interface element, such as finger of hand 628 directed to selectable user interface object 612c. For example, the request to display a user interface element includes a request to display a user interface element of an application other than the mapping application. In some embodiments, the request to display a user interface element includes a request to display two or more user interfaces simultaneously via a split screen mode. In some embodiments, the user interface element is selectable to optionally cause playback of media content (e.g., music, podcast, video, or audiobook), initiate a call, initiate an order, or view messaging content. In some embodiments, the second input includes a gaze of the user, a contact on a touch-sensitive surface, actuation of a physical input device of the vehicle, a predefined gesture (e.g., pinch gesture or air tap gesture), and/or a voice input from the user corresponding to a request to display a user interface. In some embodiments, the user interface element of the application other than the map application includes information related to the associated application as described above. In some embodiments, the electronic device changes the display of the user interface element of the application other than the map application, such as resizing and/or adding or removing information and/or selectable user interface elements related to the associated application. In some embodiments, the user interface element of the application other than the map application includes selectable user interface elements to perform actions associated with the corresponding application as described above.

In some embodiments, in response to detecting the second input, the electronic device changes the display of the first geographic area, via the first display generation component, from the second viewpoint to be from a third viewpoint different from the first viewpoint, such as the first display generation component 504a in FIG. 6N. In some embodiments, the first geographic area from the third viewpoint includes an area of the map of the first geographic area from a third simulated height less than the simulated height associated with the second viewpoint. In some embodiments, the third simulated height is greater than the simulated height associated with the second viewpoint. In some embodiments, the third viewpoint includes a third simulated camera angle that is different from the simulated camera angle of the second viewpoint. In some embodiments, the third simulated camera angle of the third viewpoint is the same as the simulated camera angle of the second viewpoint. In some embodiments, the electronic device changes the display of the first geographic area, via the second display generation component, from the first viewpoint to be from a fourth viewpoint different from the first viewpoint, such as the second display generation component in FIG. 6V. In some embodiments, the first geographic area from the fourth viewpoint includes an area of the map of the first geographic area from a fourth simulated height less than the simulated height associated with the first viewpoint. In some embodiments, the fourth simulated height is greater than the simulated height associated with the first viewpoint. In some embodiments, the fourth viewpoint includes a fourth simulated camera angle that is different from the simulated camera angle of the first viewpoint. In some embodiments, the fourth simulated camera angle of the third viewpoint is the same as the simulated camera angle of the first viewpoint.

In some embodiments, in response to detecting the second input, the electronic device displays, via the first display generation component, the user interface element, such as the first display generation component 504a including user interface 634 in FIG. 6N. In some embodiments, the electronic device displays, via the first display generation component, the user interface element in a first portion of the display generation component and the first geographic area from the second viewpoint including the first indication of the upcoming maneuver in a second portion of the display generation component that is different from the first portion. In some embodiments, the electronic device displays, via the second display generation component, the user interface element in a first portion of the display generation component and the first geographic area from the fourth viewpoint including the second indication of the upcoming maneuver in a second portion of the display generation component that is different from the first portion. In some embodiments, the first portion is a different size (e.g., smaller or larger) than the size of the second portion. In some embodiments, the first portion is a same size as the second portion. In some embodiments, the electronic device zooms in or out of the first geographic area via the first display generation component in response to receiving one or more inputs in a manner similar to that described above. In some embodiments, the electronic device zooms in or out of the first geographic area via the second display generation component in response to receiving one or more inputs in a manner similar to that described above. Providing different viewpoints of a geographic area for display including a user interface element on respective display generation components enables a user to easily view and locate map information from different vantage points and interact with the user interface element, thereby reducing the need for subsequent inputs from a user to zoom in or out of the geographic area which reduces power usage and improves battery life of the electronic device by enabling the user to use the electronic device more quickly and efficiently.

In some embodiments, while navigating along the first route, in accordance with a determination of arrival at a destination of the first route, the electronic device changes the display of the first geographic area, via the first display generation component, from the second viewpoint, such as the first display generation component 504a in FIG. 6U, to be from a third viewpoint including displaying a representation of the destination at a zoom level zoomed in from a zoom level of the third viewpoint, such as the first display generation component 504a in FIG. 6V. In some embodiments, the electronic device determines arrival at the destination of the first route when the current location of the electronic device is within a predetermined distance (e.g., 15 meters, 30 meters, 90 meters, 150 meters, 300 meters, 900 meters, 1.5 kilometers, 2 kilometers, 2.5 kilometers, 3 kilometers, or 4 kilometers) from the destination of the first route. For example, prior to arrival at the destination of the first route the electronic device displays the first geographic area, via the first display generation component, from the second viewpoint at a zoom level corresponding to the simulated aerial view of the first geographic area at the second height and/or second simulated camera angle as described above. In some embodiments, the second viewpoint at the zoom level is different from the zoom level of the third viewpoint. In some embodiments, the first geographic area from the third viewpoint includes an area of the map of the first geographic area from a third simulated height less than the simulated height associated with the second viewpoint. In some embodiments, the third viewpoint includes a third simulated camera angle that is different from the simulated camera angle of the second viewpoint. In some embodiments, the third simulated camera angle of the third viewpoint is the same as the simulated camera angle of the first viewpoint. In some embodiments, the representation of the destination includes an image and/or text identifying the destination. In some embodiments, the zoom level of the third viewpoint is a level of zoom at which trees, foliage, sidewalks, bike lanes, medians, lanes of roads, and/or cross walks are displayed. In some embodiments, the first geographic area is displayed at a level of zoom that is zoomed in on a portion of the route that corresponds to the destination. In some embodiments, while navigating along the first route, in accordance with a determination of arrival at a destination of the first route, the electronic device displays an indication of arrival at the destination of the first route via the second display generation component. For example, the indication of arrival at the destination of the first route includes an image and/or text indicating to the user that they have arrived at the destination. In some embodiments, prior to arrival at the destination of the first route the electronic device displays the first geographic area, via the second display generation component, from the first viewpoint, wherein the first viewpoint optionally includes the simulated overhead view of the first geographic area at the first height and/or first simulated camera angle as described above. In some embodiments, the electronic device maintains display, via the second display generation component, of the first geographic area from the first viewpoint in response to arrival at the destination of the first route. For example, the electronic device does not automatically change the zoom level of the first geographic area via the second display generation component. In some embodiments, the electronic device changes the zoom level of the first geographic area via the second display generation component in response to voice input from the user corresponding to the request to change the zoom level of the first geographic area as described above. Changing the display of the geographic area to be from a zoom level of a viewpoint including displaying a representation of a destination at a zoom level zoomed in from the zoom level of the viewpoint in response to a determination of arrival at the destination enables a user to easily view the representation of the destination and determine arrival at the destination, thereby reducing the need for subsequent inputs from a user to zoom in on the geographic area to view the representation of the destination which reduces power usage and improves battery life of the electronic device by enabling the user to use the electronic device more quickly and efficiently.

In some embodiments, while displaying, via the first display generation component, the first geographic area from the second viewpoint and displaying, via the second display generation component, the first geographic area from the first viewpoint, in accordance with a determination that an upcoming maneuver of a route satisfies one or more first criteria, the electronic device changes the display of the first geographic area, via the first display generation component, from the second viewpoint, such as the first display generation component 504a in FIG. 6K, to be from a first zoom level of the second viewpoint, such as for example, and in some embodiments, the first display generation component 504a including the indication of alternative route 650 in FIG. 6L at the first zoom level. In some embodiments, the one or more first criteria include a criterion that is satisfied when the location of the maneuver is less than a threshold distance from the location of the electronic device (e.g., 0.02, 0.04, 0.06, 0.08, 0.2, 0.4, 0.6, 0.8, 1, 1.5, 2, 3, 4, 5, 6, 7, 8, 9, or 10 kilometers). In some embodiments, the one or more first criteria include a criterion that is satisfied when the type of the upcoming maneuver matches a predetermined maneuver type, such as turning, exiting, merging, etc. In some embodiments, the one or more first criteria are not satisfied if the maneuver is more than the threshold distance from the location of the electronic device or if the maneuver is a type not included in the predetermined maneuver types, such as continuing straight. For example, prior to the determination that the upcoming maneuver of the route satisfies one or more first criteria, the electronic device displays the first geographic area, via the first display generation component, from the second viewpoint at a zoom level corresponding to the simulated aerial view of the first geographic area at the second height and/or second simulated camera angle as described above. In some embodiments, the second viewpoint at the zoom level is different from the first zoom level. For example, the first zoom level of the second viewpoint is optionally a level of zoom at which medians, lanes of roads, and/or cross walks are displayed. In some embodiments, the first geographic area is displayed at the first zoom level that is zoomed in on a portion of the route that corresponds to the upcoming maneuver.

In some embodiments, while displaying, via the first display generation component, the first geographic area from the second viewpoint and displaying, via the second display generation component, the first geographic area from the first viewpoint, in accordance with a determination that an upcoming maneuver of a route satisfies one or more first criteria, the electronic device changes the display of the first geographic area, via the second display generation component, from the first viewpoint, such as the second display generation component 504b in FIG. 6U, to be from a second zoom level of the first viewpoint, such as the second display generation component 504b in FIG. 6V. For example, prior to the determination that the upcoming maneuver of the route satisfies one or more first criteria, the electronic device displays the first geographic area, via the second display generation component, from the first viewpoint at a zoom level corresponding to the simulated overhead view of the first geographic area at the first height and/or first simulated camera angle as described above. In some embodiments, the first viewpoint at the zoom level is different from the second zoom level. For example, the second zoom level of the first viewpoint is optionally a level of zoom at which trees, foliage, sidewalks, bike lanes, medians, lanes of roads, and/or cross walks are displayed. In some embodiments, the second zoom level includes representations of map data at a greater level of detail than the first zoom level. In some embodiments, the first geographic area is displayed at the second zoom level that is zoomed in on a portion of the route that corresponds to the upcoming maneuver. In some embodiments, the electronic device concurrently changes the display of the first geographic area, via the first display generation component, from the second viewpoint to be from the first zoom level of the second viewpoint with the display of the first geographic area, via the second display generation component, from the first viewpoint to be from the second zoom level of the first viewpoint. Automatically changing the display of the first geographic area, via the respective display generation component to be from a respective zoom level of the respective viewpoint in response to an upcoming maneuver provides quick display of map information at a zoom level without requiring the user to provide further inputs to zoom in on the geographic area to view the upcoming maneuver which reduces power usage and improves battery life of the electronic device by enabling the user to use the electronic device more quickly and efficiently.

In some embodiments, the electronic device displays, via the first display generation component, the first geographic area from the first viewpoint includes displaying the first geographic area at a first zoom level, such as the first display generation component 504a in FIG. 6E. In some embodiments, the electronic device displays, via the second display generation component, the first geographic area from the first viewpoint includes displaying the first geographic area at a second zoom level, different from the first zoom level, such as the second display generation component 504b in FIG. 6E. In some embodiments, displaying, via the first display generation component, the first geographic area from the first viewpoint at the first zoom level includes displaying an area of the map of the first geographic area from a first simulated height greater than the simulated height associated with displaying, via the second display generation component, the first geographic area from the first viewpoint at the second zoom level. In some embodiments, displaying, via the first display generation component, the first geographic area from the first viewpoint at the first zoom level includes an area of the map of the first geographic area from a first simulated height less than the simulated height associated with displaying, via the second display generation component, the first geographic area from the first viewpoint at the second zoom level. In some embodiments, the first zoom level includes a first simulated camera angle that is different from the simulated camera angle of the second zoom level. In some embodiments, the first zoom level includes a first simulated camera angle that is the same as the simulated camera angle of the second zoom level. In some embodiments, the first viewpoint at the first zoom level includes a larger portion of the map than the portion associated with the first viewpoint at the second zoom level. In some embodiments, the first viewpoint at the first zoom level includes a larger portion of the map than the portion associated with the first viewpoint at the second zoom level. In some embodiments, the second geographic area from the second viewpoint includes a smaller portion of the map than the portion associated with the first geographic area from the second viewpoint. Displaying the first geographic area from a first viewpoint at different zoom levels enables a user to easily view and locate map information from two different vantage points, thereby reducing the need for subsequent inputs from a user to zoom in or out of the geographic area which reduces power usage and improves battery life of the electronic device by enabling the user to use the electronic device more quickly and efficiently.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIG. 7 are, optionally, implemented by components depicted in FIGS. 1A-1B. For example, displaying operations 702a and/or 702d are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is collecting location information. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, collecting location information can be used to display maps of the physical area in which the electronic device is located. Accordingly, use of such personal information data enables users to use electronic devices to view maps of relevant geographic areas. Further, other uses for personal information data that benefit the user are also contemplated by the present disclosure. For instance, location data may be used to present navigation directions while the electronic device is traveling.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable location services in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device displays maps of physical areas without sensing the current location of the electronic device.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method comprising:
at an electronic device in communication with a first display generation component, a second display generation component, and one or more input devices:
while displaying, via the first display generation component, a first area from a first viewpoint, detecting activation of the second display generation component; and
in response to detecting activation of the second display generation component:
changing the display of the first area, via the first display generation component, from the first viewpoint to be from a second viewpoint, different from the first viewpoint; and
displaying, via the second display generation component, the first area from the first viewpoint.

2. The method of claim 1, wherein the first viewpoint includes a simulated overhead view of the first area.

3. The method of claim 1, wherein the second viewpoint includes a simulated aerial view of the first area.

4. The method of claim 1, wherein displaying, via the first display generation component, the first area from the first viewpoint includes displaying the first area from the first viewpoint in a user interface of a map application, the method further comprising:
displaying, in the user interface of the map application, a user interface element selectable to change the display of the first area, via the first display generation component, from the first viewpoint to be from the second viewpoint.

5. The method of claim 4, further comprising:
while displaying, via the first display generation component, the first area from the first viewpoint, detecting, via the one or input devices, a second input that corresponds to a request to change a zoom level of the first area; and
in response to detecting the second input:
in accordance with a determination that the request to change the zoom level corresponds to changing the zoom level by a first amount, displaying, via the first display generation component, the first area at a first zoom level including changing the display of the first area from the first viewpoint to be from a third viewpoint; and
in accordance with a determination that the request to change the zoom level corresponds to changing the zoom level by a second amount, different from the first amount, displaying, via the first display generation component, the first area at a second zoom level including changing the display of the first area from the first viewpoint to be from a fourth viewpoint, different from the third viewpoint.

6. The method of claim 1, wherein displaying, via the first display generation component, the first area from the second viewpoint includes displaying navigation directions along a first route, the method further comprising:
while displaying, via the first display generation component, the navigation directions along the first route, in accordance with a determination that an upcoming route characteristic satisfies one or more first criteria:
displaying, via the first display generation component, a second area from the second viewpoint that is associated with the upcoming route characteristic; and
maintaining display, via the second display generation component, of the first area from the first viewpoint.

7. The method of claim 6, wherein displaying, via the first display generation component, the second area from the second viewpoint that is associated with the upcoming route characteristic includes displaying a user interface element, the method further comprising:
while displaying, via the first display generation component, the user interface element selectable to initiate an operation associated with the upcoming route characteristic, detecting, via the one or input devices, a second input that corresponds to selection of the user interface element; and
in response to detecting the second input:
changing the display, via the first display generation component, from the second area from the second viewpoint to be from the first area from the second viewpoint including navigation directions along a second route, different from the first route; and
displaying, via the second display generation component, the first area from the first viewpoint including an indication of the second route.

8. The method of claim 1, further comprising:
while displaying, via the first display generation component, the first area from the second viewpoint and displaying, via the second display generation component, the first area from the first viewpoint, detecting deactivation of a respective display generation component; and
in response to detecting the deactivation of the respective display generation component:
in accordance with a determination that deactivation corresponds to deactivating the first display generation component:
maintaining display, via the second display generation component, of the first area from the first viewpoint; and
ceasing to display, via the first display generation component, the first area from the second viewpoint; and
in accordance with a determination that deactivation corresponds to deactivating the second display generation component:
changing the display of the first area, via the first display generation component, from the second viewpoint to be from the first viewpoint; and
ceasing to display, via the second display generation component, the first area from the first viewpoint.

9. The method of claim 1, wherein:
displaying, via the first display generation component, the first area from the second viewpoint includes displaying first content; and
displaying, via the second display generation component, the first area from the first viewpoint includes displaying second content.

10. The method of claim 9, further comprising:
while displaying, via the first display generation component, the first area from the second viewpoint including the first content and displaying, via the second display generation component, the first area from the first viewpoint including the second content, detecting, via the one or input devices, a second input corresponding to a request to cease display of the first area via the first display generation component; and
in response to detecting the second input:
changing the display of the first area, via the second display generation component, from the first viewpoint including the second content to include third content; and
ceasing to display, via the first display generation component, the first area from the second viewpoint including the first content.

11. The method of claim 10, further comprising:
while displaying, via the second display generation component, the first area from the first viewpoint including the third content, detecting, via the one or input devices, a third input corresponding to a request to display the first area via the first display generation component; and
in response to detecting the third input:
changing the display of the first area, via the second display generation component, from the first viewpoint including the third content to include fourth content; and
displaying, via the first display generation component, the first area from the second viewpoint including fifth content different from the fourth content.

12. The method of claim 9, further comprising:
while displaying, via the first display generation component, the first area from the second viewpoint including the first content and displaying, via the second display generation component, the first area from the first viewpoint including the second content, detecting, via the one or input devices, a second input corresponding to a request to cease display of the first area via the second display generation component; and
in response to detecting the second input:
changing the display of the first area, via the first display generation component, from the second viewpoint including the first content to the first viewpoint including third content; and
ceasing to display, via the second display generation component, the first area from the first viewpoint including the second content.

13. The method of claim 12, further comprising:
while displaying, via the first display generation component, the first area from the first viewpoint including the third content, detecting, via the one or input devices, a third input corresponding to a request to display the first area via the second display generation component; and
in response to detecting the third input:
changing the display of the first area, via the first display generation component, from the first viewpoint including the third content to the second viewpoint including fourth content; and
displaying, via the second display generation component, the first area from the first viewpoint including fifth content different from the fourth content.

14. The method of claim 9, further comprising:
while displaying, via the first display generation component, the first area from the second viewpoint including the first content and displaying, via the second display generation component, the first area from the first viewpoint including the second content, detecting, via the one or input devices, a second input corresponding to a request to display a user interface element; and
in response to detecting the second input:
displaying, via the first display generation component, the user interface element and third content, different from the first content or displaying, via the second display generation component, fourth content, different from the second content.

15. The method of claim 9, further comprising:
while displaying, via the first display generation component, the first area from the second viewpoint including the first content and displaying, via the second display generation component, the first area from the first viewpoint including the second content, detecting, via the one or input devices, a second input corresponding to a request to display a user interface element; and
in response to detecting the second input:
changing the display of the first area, via the first display generation component, from the second viewpoint to be from a third viewpoint different from the second viewpoint or changing the display of the first area, via the second display generation component, from the first viewpoint to be from a fourth viewpoint different from the first viewpoint; and
displaying, via the first display generation component, the user interface element.

16. The method of claim 1, further comprising:
while navigating along a first route and while displaying, via the first display generation component, the first area from the first viewpoint and displaying, via the second display generation component, the first area from the second viewpoint, in accordance with a determination that an upcoming maneuver of the first route satisfies one or more first criteria:
displaying, using the first display generation component, a first indication of the upcoming maneuver; and
displaying, via the second display generation component, a second indication of the upcoming maneuver, different from the first indication of the upcoming maneuver.

17. The method of claim 16, further comprising:
while displaying, via the first display generation component, the first area from the second viewpoint including the first indication of the upcoming maneuver and displaying, via the second display generation component, the first area from the first viewpoint including the second indication of the upcoming maneuver, detecting, via the one or input devices, a second input corresponding to a request to cease display of the first area via the first display generation component; and
in response to detecting the second input:
changing the display of the first area, via the second display generation component, from the first viewpoint including the second indication of the upcoming maneuver to include a third indication of the upcoming maneuver; and
ceasing to display, via the first display generation component, the first area from the second viewpoint including the first indication of the upcoming maneuver.

18. The method of claim 17, further comprising:
while displaying, via the second display generation component, the first area from the first viewpoint including the third indication of the upcoming maneuver, detecting, via the one or input devices, a third input corresponding to a request to display the first area via the first display generation component; and
in response to detecting the third input:
changing the display of the first area, via the second display generation component, from the first viewpoint including the third indication of the upcoming maneuver to include a fourth indication of the upcoming maneuver; and
displaying, via the first display generation component, the first area from the second viewpoint including a fifth indication of the upcoming maneuver.

19. The method of claim 16, further comprising:
while displaying, via the first display generation component, the first area from the second viewpoint including the first indication of the upcoming maneuver and displaying, via the second display generation component, the first area from the first viewpoint including the second indication of the upcoming maneuver, detecting, via the one or input devices, a second input corresponding to a request to cease display of the first area via the second display generation component; and
in response to detecting the second input:
changing the display of the first area, via the first display generation component, from the second viewpoint including the first indication of the upcoming maneuver to the first viewpoint including a third indication of the upcoming maneuver; and
ceasing to display, via the second display generation component, the first area from the first viewpoint including the second indication of the upcoming maneuver.

20. The method of claim 19, further comprising:
while displaying, via the first display generation component, the first area from the first viewpoint including the third indication of the upcoming maneuver, detecting, via the one or input devices, a third input corresponding to a request to display the first area via the second display generation component; and
in response to detecting the third input:
changing the display of the first area, via the first display generation component, from the first viewpoint including the third indication of the upcoming maneuver to the second viewpoint including a fourth indication of the upcoming maneuver; and
displaying, via the second display generation component, the first area from the first viewpoint including a fifth indication of the upcoming maneuver.

21. The method of claim 16, further comprising:
while displaying, via the first display generation component, the first area from the second viewpoint including the first indication of the upcoming maneuver and displaying, via the second display generation component, the first area from the first viewpoint including the second indication of the upcoming maneuver, detecting, via the one or input devices, a second input corresponding to a request to display a user interface element; and
in response to detecting the second input:
displaying, via the first display generation component, the user interface element; and;
displaying, via the first display generation component, a third indication of the upcoming maneuver, different from the first indication of the upcoming maneuver or displaying, via the second display generation component, a fourth indication of the upcoming maneuver, different from the second indication of the upcoming maneuver.

22. The method of claim 16, further comprising:
while displaying, via the first display generation component, the first area from the second viewpoint including the first indication of the upcoming maneuver and displaying, via the second display generation component, the first area from the first viewpoint including the second indication of the upcoming maneuver, detecting, via the one or input devices, a second input corresponding to a request to display a user interface element; and
in response to detecting the second input:
changing the display of the first area, via the first display generation component, from the second viewpoint to be from a third viewpoint different from the first viewpoint or changing the display of the first area, via the second display generation component, from the first viewpoint to be from a fourth viewpoint different from the first viewpoint; and
displaying, via the first display generation component, the user interface element.

23. The method of claim 16, further comprising:
while navigating along the first route, in accordance with a determination of arrival at a destination of the first route:
changing the display of the first area, via the first display generation component, from the second viewpoint to be from a third viewpoint including displaying a representation of the destination at a zoom level zoomed in from a zoom level of the third viewpoint.

24. The method of claim 1, further comprising:
while displaying, via the first display generation component, the first area from the second viewpoint and displaying, via the second display generation component, the first area from the first viewpoint, in accordance with a determination that an upcoming maneuver of a route satisfies one or more first criteria:
changing the display of the first area, via the first display generation component, from the second viewpoint to be from a first zoom level of the second viewpoint; and
changing the display of the first area, via the second display generation component, from the first viewpoint to be from a second zoom level of the first viewpoint.

25. The method of claim 2, wherein:
displaying, via the first display generation component, the first area from the first viewpoint includes displaying the first area at a first zoom level; and
displaying, via the second display generation component, the first area from the first viewpoint includes displaying the first area at a second zoom level, different from the first zoom level.

26. An electronic device comprising:
one or more processors;
memory; and
one or more programs, wherein the one or more programs are stored in the memory and configured to be executed by the one or more processors, the one or more programs including instructions for:
while displaying, via a first display generation component, a first area from a first viewpoint, detecting activation of a second display generation component; and
in response to detecting activation of the second display generation component:
changing the display of the first area, via the first display generation component, from the first viewpoint to be from a second viewpoint, different from the first viewpoint; and
displaying, via the second display generation component, the first area from the first viewpoint.

27. A non-transitory computer readable storage medium storing one or more programs, the one or more programs comprising instructions, which when executed by one or more processors of an electronic device, cause the electronic device to perform a method comprising:
while displaying, via a first display generation component, a first area from a first viewpoint, detecting activation of a second display generation component; and
in response to detecting activation of the second display generation component:
changing the display of the first area, via the first display generation component, from the first viewpoint to be from a second viewpoint, different from the first viewpoint; and
displaying, via the second display generation component, the first area from the first viewpoint.
